(19) United States
(12) Patent Application Publication
(10) Pub. No.: US 2026/0310947 A1
(43) Pub. Date: Oct. 8, 2026

(54) METHOD AND SYSTEM FOR ACCELERATED ATTENTION OPERATIONS IN A MACHINE LEARNING MODEL AND DIFFERENTIABLE POINT RENDERING USING PROXIMITY ATTENTION

(71) Applicant: Algorithmically Principled Exploration (APEX) Lab, Burnaby (CA)

(72) Inventors: Yanshu Zhang, Burnaby (CA); Yuzhen Mao, Burnaby (CA); Shichong Peng, Maple Ridge (CA); Seyed Alireza Moazenipourasil, Burnaby (CA); Ke Li, Burnaby (CA)

(21) Appl. No.: 19/485,264

(22) PCT Filed: May 17, 2024
(86) PCT No.: PCT/CA2024/050671

§ 371 Date: Nov. 17, 2025

Related U.S. Application Data
(60) Provisional application No. 63/502,797, filed on May 17, 2023.

(51) Int. Cl. G06N 3/048; G06N 3/0464; G06N 3/084; G06V 10/77

(52) U.S. Cl. CPC G06N 3/048; G06N 3/0464; G06N 3/084; G06V 10/7715

(57) ABSTRACT

There is provided a method and system for accelerated operation of layers used in a machine learning model. The method including: receiving rows or columns of a weight matrix, an input vector, and columns of an identity matrix; transforming the rows or columns of the weight matrix and the input vector using an embedding function; performing a search to identify transformed rows or columns of the weight matrix that are to receive high post-activations; determining post-activations using similarity of the rows or columns of the weight matrix that were returned by the search to the associated input vector as measured by a kernel function; determining an output matrix that makes the output matrix equivalent to the post-activations where the post-activations are value vectors, and otherwise, combining the post-activations with the associated value vectors; and outputting the output matrix.

### TECHNICAL FIELD

The following relates generally to machine learning models, and more specifically, to a method and system for accelerated operation of layers used in a machine learning model and differentiable point rendering using proximity attention.

### BACKGROUND

A common operation performed in many neural networks is an attention operation. Where, given a set of keys, queries, and values that are represented as vectors, for each query, the attention operation combines the values in a way that gives higher weight to values whose keys are more important to the query and lower weight to values whose keys are less important to the query. The keys that are important to a query are said to be attended to by the query. How important each key is to a query can be determined based on how similar the key is to the query. The attention operation generally determines an output in two steps. First, by computing the attention weights from the keys and queries, which are numbers between 0 and 1 that represent how important each key is to each query. Then, by combining the values together with the attention weights, to yield a single output vector for each query.

### SUMMARY

In an aspect, there is provided a processor-executed method for accelerated operation of layers used in a machine learning model, the method comprising: receiving rows or columns of a weight matrix, an input vector, and columns of an identity matrix, where each row or column of the weight matrix is associated with a value vector; transforming the rows or columns of the weight matrix and the input vector using an embedding function; performing a search to identify transformed rows or columns of the weight matrix that are to receive high post-activations based on each of the transformed input vector; determining post-activations using similarity of the rows or columns of the weight matrix that were returned by the search to the associated input vector as measured by a kernel function; and outputting the post-activations for operation of the layers used in the machine learning model.

In a particular case of the method, the method further comprising determining an output matrix comprising making the output matrix equivalent to the post-activations where the post-activations are value vectors, and otherwise, combining the post-activations with the associated value vectors; and outputting the output matrix for use in the machine learning model.

In another case of the method, transforming the rows or columns of the weight matrix and the input vector using the embedding function comprises embedding the rows or columns of the weight matrix and the input vector into a higher dimensional space.

In yet another case of the method, the search comprises a k-nearest neighbour search over the transformed rows or columns of the weight matrix given each transformed query to identify transformed rows or columns of the weight matrix that have higher importance to each of the transformed input vector.

In yet another case of the method, the search comprises one of: returning all or a subset of points within a particular radius of the query or whose similarities to the query pass a threshold; determining points that are near or similar to the query; clustering points that are near or similar to one another and return points in clusters that are near the query; constructing a graph with points as nodes and connect nearby or similar points with edges and traverse the graph; and estimating a probability density of points and return points near or similar to the query whose probability densities pass a threshold.

In yet another case of the method, the method further comprising receiving a mask matrix, wherein the search uses only rows or columns of the weight matrix that are not masked in the mask matrix.

In yet another case of the method, determining the post-activations further comprises modifying post-activations to account for the post-activations of the rows or columns of the weight matrix that were not identified by the search.

In yet another case of the method, the rows or columns of the weight matrix that were not identified in the search are treated as if the kernel function applied to each of those rows or columns of the weight matrix and the query evaluates to a constant.

In yet another case of the method, a value of the constant is fixed or wherein the value of the constant is determined by sampling a subset of rows or columns of the weight matrix at random, wherein during such determination, the kernel function is evaluated by application to the sampled rows or columns of the weight matrix and the query, and the evaluations are combined for each key by determining an average.

In yet another case of the method, determining the output matrix comprises treating the value vectors associated with rows or columns of the weight matrix that were not identified by the search as though the value vectors evaluate to a constant vector.

In yet another case of the method, the layer comprises an attention operation, the post-activations comprise attention weights, and the rows or columns of the weight matrix comprise key.

In another aspect, there is provided a system for accelerated attention operations for use in a machine learning model, the system comprising a processing unit and a data storage, the data storage comprising executable instructions that when executed by the processing unit cause to the system to: receive rows or columns of a weight matrix, an input vector, and columns of an identity matrix, where each row or column of the weight matrix is associated with a value vector; transform the rows or columns of the weight matrix and the input vector using an embedding function; perform a search to identify transformed rows or columns of the weight matrix that are to receive high post-activations based on each of the transformed input vector; determine post-activations using similarity of the rows or columns of the weight matrix that were returned by the search to the associated input vector as measured by a kernel function; and output the post-activations for operation of the machine learning model.

In a particular case of the system, the executable instructions are further used to execute determination of an output matrix comprising making the output matrix equivalent to the post-activations where the post-activations are value vectors, and otherwise, combining the post-activations with the associated value vectors; and output the output matrix for use in the machine learning model.

In another case of the system, transforming the rows or columns of the weight matrix and the input vector using the embedding function comprises embedding the rows or columns of the weight matrix and the input vector into a higher dimensional space.

In yet another case of the system, the search comprises a k-nearest neighbour search over the transformed rows or columns of the weight matrix given each transformed query to identify transformed rows or columns of the weight matrix that have higher importance to each of the transformed input vector.

In yet another case of the system, the search comprises one of: returning all or a subset of points within a particular radius of the query or whose similarities to the query pass a threshold; determining points that are near or similar to the query; clustering points that are near or similar to one another and return points in clusters that are near the query; constructing a graph with points as nodes and connect nearby or similar points with edges and traverse the graph; and estimating a probability density of points and return points near or similar to the query whose probability densities pass a threshold.

In yet another case of the system, determining the post-activations further comprises modifying post-activations to account for the post-activations of the rows or columns of the weight matrix that were not identified by the search.

In yet another case of the system, the rows or columns of the weight matrix that were not identified in the search are treated as if the kernel function applied to each of those rows or columns of the weight matrix and the query evaluates to a constant.

In yet another case of the system, a value of the constant is fixed or wherein the value of the constant is determined by sampling a subset of rows or columns of the weight matrix at random, wherein during such determination, the kernel function is evaluated by application to the sampled rows or columns of the weight matrix and the query, and the evaluations are combined for each key by determining an average.

In yet another case of the system, determining the output matrix comprises treating the value vectors associated with rows or columns of the weight matrix that were not identified by the search as though the value vectors evaluate to a constant vector.

In another aspect, there is provided a processor-executed method for differentiable point rendering using proximity attention to learn a representation of a three-dimensional (3D) scene, the method comprising: receiving an input matrix derived from a set of images; initializing points in the 3D scene; extracting ray-to-point features using the points and the input matrix; aggregating the ray-to-point features to generate a feature map that represents surface-ray intersections; generating an image prediction, using a convolutional neural network, and taking the feature map as input; and outputting the image prediction as the representation of the 3D scene.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for accelerated attention operations in a machine learning model and differentiable point rendering using proximity attention, in accordance with various embodiments;

FIG. 2 is a flowchart for a method for accelerated attention operations in a machine learning model, in accordance with an embodiment;

FIG. 3 illustrates an example implementation of a prior approach to perform attention operations compared to the approach to attention operations of the method of FIG. 2;

FIGS. 4A to 4C show diagrams of an example of an end-to-end learnable point-based rendering pipeline, where FIG. 4A shows ray, point features, FIG. 4B shows an attention layer, and FIG. 4C shows a generator;

FIG. 5 is a flowchart showing a method for differentiable point rendering using proximity attention to learn representation of a three-dimensional (3D) scene, in accordance with an embodiment;

FIGS. 6A and 6B show an example of learned point coordinates and features, where

FIG. 6A shows a reference scene and FIG. 6B shows the learned point cloud for that scene;

FIG. 7 is an example diagram of a neural network architecture for performing at least portions of the method of FIG. 5;

FIG. 8 is a qualitative comparison of the method of FIG. 5 on a NeRF Synthetic dataset in comparison to a baseline and other approaches;

FIG. 9 is a chart illustrating an ablation study on the effect of the number of points on rendered image quality showing that increasing the number of points improves the performance of the method of FIG. 5;

FIG. 10 is a chart illustrating an ablation study on ray-dependent point embedding for the method of FIG. 5.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to machine learning models, and more specifically, to a method and system for accelerated attention operations in a machine learning model and differentiable point rendering using proximity attention.

Mathematically, an attention operation, in the context of machine learning models, takes three matrices as input, K∈ [symbol] , Q∈ [symbol] , V∈ [symbol] , which denote keys, queries, and values respectively, and outputs a matrix O∈ [symbol] . Each key is associated with a value. A pair of key and value is known as a token. In some cases, the attention operation may also take in a mask as input, S∈ [symbol] , whose entries are either 0 or 1. The ith rows of K, Q, V and O, can be denoted as kᵢ, qᵢ, vᵢ and oᵢ, and represent the ith key, query, value and output respectively. The entry of S in the ith row and jth column, denoted as s_{i,j}, represents whether the ith query is allowed to attend to the jth key; where if it is 1, it would be allowed, and if it is 0, it would not be. When the mask S is not specified, all its entries are generally assumed to be 1. Keys and queries have the same dimension d, and each key is associated with a value, and so the number of keys and values is the same and denoted as m.

In most cases, the attention operation can first determine an attention weight matrix A∈ [symbol] . Commonly, its entry in the ith row and jth column, denoted as a_{i,j}, is computed with the following:

$${a}_{i , j} = \frac{{s}_{i , j} exp ( \frac{k ( {q}_{i} , {k}_{j} )}{\sqrt{d}} )}{{\sum }_{j ′ = 1}^{m} {s}_{i , j ′} exp ( \frac{k ( {q}_{i} , {k}_{j ′} )}{\sqrt{d}} )} := {MaskedSoftmax}_{j} ( {\{ ( \frac{k ( {q}_{i} , {k}_{j ′} )}{\sqrt{d}} , {s}_{i , j ′} ) \}}_{j ′ = 1}^{m} ) \qquad ( 1 )$$

where k: [symbol] × [symbol] → [symbol] is a function that returns a score measuring the similarity between its input arguments, which is known as a kernel function. For example, the kernel function can be the dot product, i.e.,

$$k ( {q}_{i} , {k}_{j ′} ) := {q}_{i}^{T} {k}_{j ′}$$

or the negative Euclidean distance k(qᵢ, k_{j′}):=−∥qᵢ−kⱼ, ∥₂. The functions MaskedSoftmaxⱼ for different j's can be viewed as different components of a vector-valued function MaskedSoftmax. In other cases, it can be replaced with another vector-valued function that yields non-negative values for each component that sum up to a fixed constant; e.g., the softmax function, the sparsemax function or any other function that maps an m-dimensional vector space to a m−1-dimensional simplex.

The attention operation can combine the values with the attention weights by:

$${o}_{i} = {\sum }_{j = 1}^{m} {a}_{i , j} {v}_{j} \qquad ( 2 )$$

To differentiate the cases where the mask S is specified versus not specified, the former is sometimes known as masked attention, whereas the latter can be known as attention or vanilla attention. A special case of masked attention is causal attention, where the mask is one for all keys whose positions are before the position of the query, and zero otherwise; i.e., s_{i,j}=1 if i>j, and s_{i,j}=0 if i≤j.

Another special case of both vanilla and masked attention is self-attention, which always has the same number of keys and queries. In self-attention, the ith key and query are typically functions of the same vector. Vanilla attention, vanilla self-attention, and causal self-attention form the basis of a class of neural network architectures, known as transformers.

In many neural network models, both the number of keys m and the number of queries n can be large. For example, in language models, which generate plausible continuations of a given textual prompt, each key represents either a word in the prompt or a previously generated word, and each query represents a word currently being generated. To generate coherent text, such models need to capture long-range dependencies, which generally require each query to be able to attend to a large context of words in the prompt and previously generated words. Generally, this is not computationally feasible, because the amount of time and space required to compute and store attention weights A and O and/or the gradient with respect to A and O is O(dmn) and O(d′mn), respectively, which is quadratic in the context length. As a result, when m and n get large, attention becomes very computationally expensive in both time and space. Consequently, the computational bounds of modern hardware generally force a limit on the context length, which prevents long-range dependencies from being fully modelled.

In the context of transformer-based architectures, various approaches have tried to address this issue. Generally, such approaches rely on one of two strategies: sparse approximations and low-rank approximations. Sparsity-based approaches generally only attend to a subset of the keys, whereas low-rank approaches generally approximate the attention weight matrix with a product of tall and wide matrices. Most of such approaches require modifying the architecture to constrain the operations of the model or add learnable parameters, and so must be retrained. As a result, they cannot be applied off-the-shelf to pre-trained, non-modified, models.

In many cases, retraining models is not practical or economical, due to the huge amounts of computational resources required to train modern models on vast datasets. Instead, it is advantageous to have an approach that does not require retraining. Currently, all such approaches are low-rank-based; for example, multiplying key and query matrices with random projection matrices, or truncating least significant singular values of predefined sub-matrices. Such approaches tend to incur high approximation errors, because constraining the rank induces dependence among different keys, and different queries, which may not have existed originally. On the other hand, sparsity-based approaches generally do not suffer from these problems.

Several substantial challenges exist for a sparsity-based approach that does not require retraining. On the one hand, sparse approximations require identifying which keys are the most important to each query, which are typically different across different queries. On the other hand, no learnable parameters can be introduced, so the way in which such keys are identified must not change depending on the data. In order to do so without missing important keys, a system can iterate over all keys and compute the importance of each to the query. Unfortunately, this would also have quadratic computational complexity, which does not allow for a large number of keys and/or queries; thus, identification of which keys are important without actually computing their importance is likely needed.

As described, there has been substantial effort in the field of machine learning to make transformers more computationally efficient by reducing the quadratic time or space complexity of the self-attention mechanism. These approaches are collectively known as efficient transformers. They can be categorized along two axes: method type and compatibility with pretrained models. Along the first axis are sparsity-based methods and low-rank methods. Along the second axis are methods that cannot be applied to pretrained, non-modified, transformer models without retraining, and methods that can be applied.

Sparsity-based methods employ a sparsified attention mechanism to capture global information and integrate it with local attention results. Notable examples include Sparse Transformer, Longformer, and Extended Transformer Construction (ETC). A substantial limitation of these models is that the tokens that are attended to are predefined and remain static, which do not adapt to varying input sequences. Because the original attention operation is permitted to attend to any token, these models must be trained with their respective predefined constraints on tokens to be attended to. Reformer can attend to different sets of tokens for different input sequences by using Locality Sensitive Hashing (LSH) to group tokens into chunks and subsequently attending only to tokens within the same chunk as each query and adjacent chunks. However, Reformer imposes two constraints that are not in the original attention operation: keys must be normalized and queries and keys must be the same.

Therefore, Reformer must be trained with these constraints built-in. As a result, these methods cannot be applied to pretrained, non-modified, models directly; instead, the models must be retrained with the required constraints before these methods can be used.

Low-rank methods approximate the attention weight matrix with a low-rank matrix to reduce the quadratic time and space complexity. Examples of low-rank transformers include Linformer and Performer, which decompose the attention weight matrix into a product of tall and wide matrices consisting of learned linear features or random features of the keys and queries, respectively. However, these transformers typically introduce significant approximation errors because attention weight matrices produced by the original attention operation, especially in the case of long input sequences, typically have high rank. Consequently, models that use these approaches must be trained with low-rank approximations built-in, in order to learn to be robust to the associated approximation errors. As a result, these approaches cannot be applied to pretrained, non-modified, models directly; instead, the models must be retrained with the required approximations before these methods can be used.

Other approaches provide more general methodologies that can leverage weights pretrained with standard transformers without retraining. These transformers accelerate the execution of the standard attention operation without altering the underlying architecture. Two examples are Nyströmformer and LARA, which replace the softmax structure in the self-attention mechanism with the product of separately activated query and key matrices. Nyströmformer utilizes the Nyström method, while LARA combines randomized attention (RA) and random feature attentions (RFA) to reconstruct the attention weight matrix. In another example, H-Transformer-1D recursively divides the attention weight matrix into blocks and truncates the small singular values of each off-diagonal blocks. All these approaches leverage low-rank approximations, as opposed to sparsity.

The present inventors have determined that the attention weight matrix A is commonly sparse, i.e., in each row of A, only a few attention weights have significant (large) values, while the majority of the remaining values are close to zero. This sparsity in the attention weight matrix is consistent with function of the attention operation: only a few tokens in the input sequence are highly relevant to a given context, and the model selectively focuses on those tokens while processing the sequence.

TABLE 1 includes an example assessment of the sparsity of learned attention matrices on five different tasks in the LRA benchmark. Three different settings were tried by only keeping the values of the top-5, top-10 and top-20 largest attention weights in each row of the attention weight matrix, and setting all the rest of the attention weights to zero. Based on the results, it was determined that although the input sequence is very long (more than 1 k tokens), attending to only 1% of the tokens with the highest attention weights will on average cover tokens whose total attention weight amounts to 89% of the total attention weight received by all tokens. This phenomenon can be exploited to achieve greater computational efficiency, especially in scenarios where sequences are long, as it reduces the number of tokens that need to be combined by attention without significantly hurting model performance.

Embodiments of the present disclosure advantageously leverage this sparsity to accelerate the inference of the transformers and reduce its memory-cost at the same time. In this way, the embodiments of the present disclosure provide a sparsity-based approach that does not require retraining.

TABLE 1
Quantitative Assessment of the Attention Matrix Sparsity

| Sparsity | Retrieval | ListOps | Text | Image | Pathfinder | Avg |
|---|---|---|---|---|---|---|
| Top-5 | 0.726 | 0.734 | 0.894 | 0.991 | 0.907 | 0.850 |
| Top-10 | 0.782 | 0.800 | 0.934 | 0.997 | 0.957 | 0.894 |
| Top-20 | 0.830 | 0.861 | 0.962 | 0.999 | 0.982 | 0.927 |

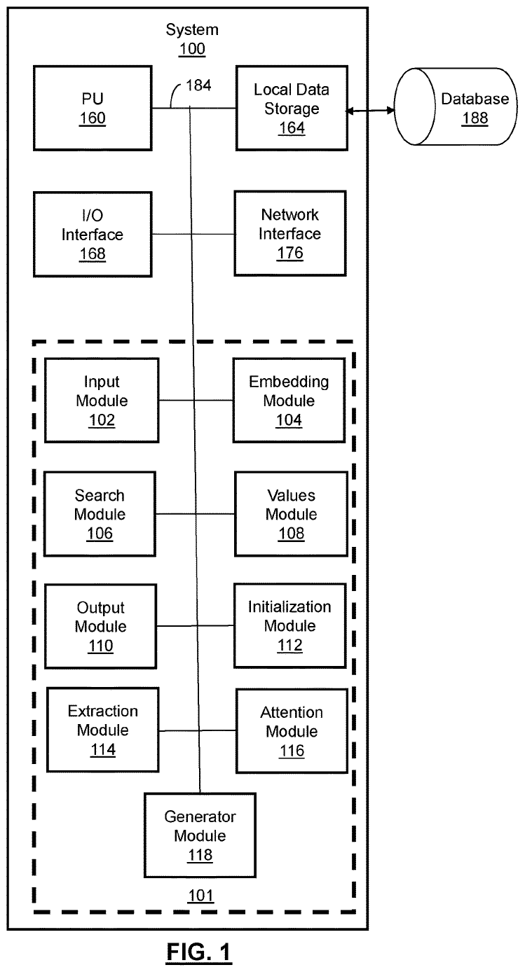

FIG. 1 illustrates a schematic diagram of a system 100 for accelerated attention operations in a machine learning model and differentiable point rendering using proximity attention, according to various embodiments. As shown, the system 100 has a number of physical and logical components, including a processing unit (“PU”) 160, local data storage 164, an input/output (I/O) interface 168, a network interface 176, and a local bus 184 enabling PU to communicate with the other components. PU 160 can include one or more central processing units, one or more graphical processing unit, microprocessors, dedicated hardware, or other integrated processing circuits. The local data storage 264 provides relatively responsive storage to PU 260. The I/O interface 168 enables input to be provided; for example, directly via a user input device, or indirectly, for example, via an external device. The I/O interface 168 also enables output to be provided; for example, directly via a user display, or indirectly, for example, sent over the network interface 176. The network interface 176 permits communication with other systems or computing devices; for example, over a local area network or over the Internet. The local data storage 164 can store an operating system and programs, including computer-executable instructions for implementing the methods described herein, as well as any derivative or related data. In some cases, this data can be stored in a database 188. In some cases, during operation of the system 100, the operating system, the programs, and the data may be retrieved from the database 188 280 and placed in local storage 164 to facilitate execution. In other embodiments, any operating system, programs, or instructions can be executed in hardware, specialized microprocessors, logic arrays, or the like. While FIG. 1 illustrates a system implemented on a single computing device, it is understood that the processing, or any of the functions undertaken by the system 100, can be distributed over multiple computing devices; for example, in a cloud or distributed computing environment.

In an embodiment, the PU 160 can be configured to execute a number of conceptual modules 101; for example, an input module 102, an embedding module 104, a search module 106, a values module 108, an output module 110, an initialization module 112, an extraction module 114, an attention module 116, and a generator module 118. In further cases, functions of the above modules can be combined or executed on other modules. In some cases, functions of the above modules can be executed on remote computing devices, such as centralized servers and cloud computing resources communicating over the network interface 176.

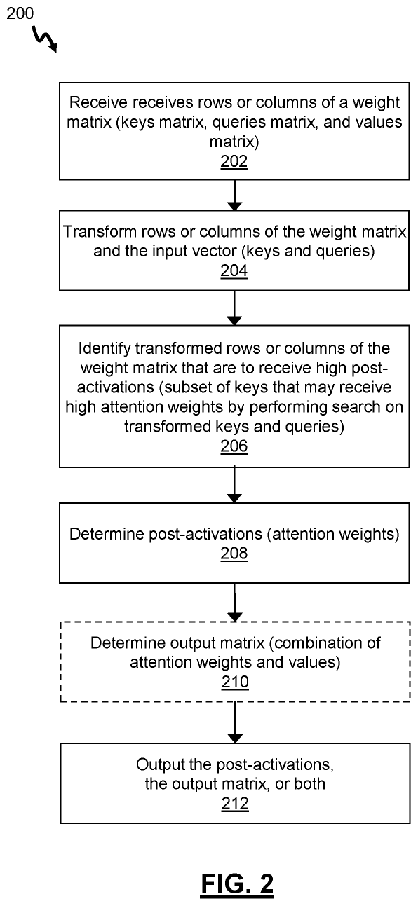

FIG. 2 illustrates a method 200 for accelerated operation of layers used in a machine learning model, in accordance with an embodiment. In a particular case, the method 200 is for accelerated attention operations in the machine learning model. The method can informally be referred to as “DCI-atten”.

At block 202, the input module 102 receives rows or columns of a weight matrix, an input vector, and columns of an identity matrix, where each row or column of the weight matrix is associated with a value vector. In the particular case of attention operations, the input module receives a keys matrix, a queries matrix, and a values matrix, where each key is associated with a value.

At block 204, the embedding module 104 transforms the rows or columns of the weight matrix and the input vector using an embedding function. In the particular case of attention operations, the embedding module 104 transforms the keys in the keys matrix and the queries in the queries matrix using embedding functions. In this way, the keys and queries are embedded into a higher dimensional space.

Below are various (non-exhaustive) examples of embeddings that can be used:

Let T_{K} and T_{Q} denote the key and query embedding functions respectively.

First example embedding function:
Let T_{K}: [symbol] → [symbol] and T_{Q}: [symbol] → [symbol] be defined as follows:

$${T}_{K} ( {k}_{j} ) = [ {k}_{j} / c \sqrt{1 - {‖ {k}_{j} ‖}_{2}^{2} / {c}^{2}} ]$$

$${T}_{Q} ( {q}_{i} ) = [ {q}_{i} / {‖ {q}_{i} ‖}_{2} 0 ]$$

where c≥maxⱼ, ∥kⱼ, ∥₂ is the maximum norm among all data points.

Second example embedding function:
Let T_{K}: [symbol] → [symbol] and T_{Q}: [symbol] → [symbol] be defined as follows:

$${T}_{K} ( {k}_{j} ) = [ {k}_{j} / c \sqrt{1 - {‖ {k}_{j} ‖}_{2}^{2} / {c}^{2}} 0 ]$$

$${T}_{Q} ( {q}_{i} ) = [ {q}_{i} / c 0 \sqrt{1 - {‖ {q}_{i} ‖}_{2}^{2} / {c}^{2}} ]$$

where

$$c \geq {max}_{} ( {max}_{j} , {‖ {k}_{{j}^{′}} ‖}_{2} , {max}_{{i}^{′}} {‖ {q}_{{i}^{′}} ‖}_{2} )$$

is the maximum norm among all data points and queries.

Third example embedding function:
Let T_{K}: [symbol] → [symbol] and T_{Q}: [symbol] → [symbol] be defined as follows:

$${T}_{K} ( {k}_{j} ) = [ {k}_{j} / c {‖ {k}_{j} ‖}_{2}^{2} / {c}^{2} … {‖ {k}_{j} ‖}_{2}^{2 s} / {c}^{2 s} ]$$

$${T}_{Q} ( {q}_{i} ) = [ {q}_{i} / {‖ {q}_{i} ‖}_{2} 1 / 2 … 1 / 2 ]$$

where c≥maxⱼ, ∥kⱼ, ∥₂ is the maximum norm among all data points.

Fourth example embedding function:
Let T_{K}: [symbol] → [symbol] and T_{Q}: [symbol] → [symbol] be defined as follows:

$${T}_{K} ( {k}_{j} ) = [ {k}_{j} \sqrt{{c}^{2} - {‖ {k}_{j} ‖}_{2}^{2}} ]$$

$${T}_{Q} ( {q}_{i} ) = [ {q}_{i} 0 ]$$

where c≥maxⱼ, ∥kⱼ, ∥₂ is the maximum norm among all data points.

While the above embedding functions are most appropriate when the kernel function is the dot product, i.e.,

$$k ( {q}_{i} , {k}_{j ′} ) := {q}_{i}^{T} {k}_{j ′}$$

the embedding functions can be used when the kernel function is different; and different embedding functions can also be used when the kernel function is different. In the latter case, new embedding functions can be derived based on what the kernel function is. For example, each symmetric positive-definite kernel function can be associated with a finite-dimensional or infinite-dimensional, and possibly stochastic, feature map φ(·); such that k(qᵢ, k_{j′})= [symbol] φ(qᵢ), φ(k_{j′}) [symbol] or k(qᵢ, k_{j′})=E[ [symbol] φ(qᵢ), φ(k_{j′}) [symbol] ]. Optionally, the feature map may be approximated, for example, with a lower dimensional feature map derived from the original feature map. Then, either the original or the approximate feature map can be generated using the embedding functions above or other embedding functions to yield new embedding functions. Embedding functions can also be derived directly by designing each component of the embedding so that the distance between resulting embedding vectors is mathematically related or equivalent to the kernel function.

At block 206, the search module 106 identifies transformed rows or columns of the weight matrix that are to receive high post-activations based on each of the transformed input vector. In the particular case of attention operations, the search module 106 identifies a subset of keys that may receive high attention weights by performing search over the transformed keys given each transformed query (for example, with sublinear query time). In an example, the search can be an efficient k-nearest neighbour search over the transformed keys given each transformed query to identify transformed keys that are important to each of the transformed queries. The k-nearest neighbour search returns k points that are closest to an input query. Other suitable search approaches and algorithms can also be used. In the example of a k-nearest neighbour search, the k-nearest neighbours for each transformed query are determined and the search returns the indices of k nearest transformed keys to each transformed query and their Euclidean distances to the transformed query.

Other search algorithms that select points based on some notion of distance or measure of similarity to the query or other points can also be used. For example, (1) algorithms that return all or a subset of points within a particular radius of the query or whose similarities to the query pass a threshold, (2) algorithms that find points that are near or similar to the query (but may not be the nearest) and return them, (3) algorithms that cluster points that are near or similar to one another and return points in clusters that are near the query, (4) algorithms that construct a graph with points as nodes and connect nearby or similar points with edges and traverse the graph, and (5) algorithms that estimate the probability density of points and return points near or similar to the query whose probability densities pass a threshold. The distance or measure of similarity used in these algorithms could be computed in the space contained by the transformed keys or queries, or some other derived space, such as the projection of the original space onto some subspace, or a linear or non-linear transformation of the original space that may have a different dimensionality from the original space.

In some cases, the input module 102 further receives a mask matrix as input and only keys that are not masked are used in the search.

At block 208, the search module 106 determines post-activations using similarity of the rows or columns of the weight matrix that were returned by the search to the associated input vector as measured by a kernel function. In the particular case of attention operations, the search module 106 determines attention weights using the keys identified by the search module 106 and the associated queries. The attention weights, which are used for accelerated attention operations, can be determined by applying an attention operation to the identified subset of keys, rather than the full set of keys. In some cases, the attention weights are modified to account for the attention weights of the keys that were not identified by the search. If a kernel function is different than a measure of distance or similarity returned by the search, then the search module 106 can directly calculate the value of the kernel function from the keys and queries or convert the returned distance or similarity score to the value of the kernel function. For example, the kernel function can be an inner product between the keys and queries, and the distance returned by the search algorithm can be the Euclidean distance. In this way, the search module 106 can either directly compute the inner product from the keys and queries, or can take advantage of what is returned by the search and derive the inner product from it. In an example, a k-nearest neighbour search may return Euclidean distances rather than inner products, and it may be more computationally efficient to convert Euclidean distances to inner products than to compute inner products de novo.

At block 210, in some cases, the values module 108 determines an output matrix comprising making the output matrix equivalent to the post-activations where the post-activations are value vectors, and otherwise, combining the post-activations with the associated value vectors. In the particular case of attention operations, the values module 108 determines an output matrix by combining the attention weights with the values.

To account for attention weights of the keys that were not identified by the search, identified at block 208, the search module 106 may, in some cases, treat keys that were not identified in the search as if the kernel function applied to each of those keys and the query evaluates to a constant; and determine the attention weights based on this assumption. In some cases, the value of the constant may be fixed. In other cases, the value of this constant can be determined, for example, by sampling a subset of keys at random either independently of the search or based on the search results. During such determination, the search module 106 can evaluate the kernel function applied to the sampled keys and the query, and combining the evaluations for each key by averaging them, for example. In some cases, the search module 106 can also treat different keys, that were not identified, differently; for example, by treating each of such keys as if the kernel function applied to the key and the query evaluates to a different constant. The value of this constant may be based on evaluation of the kernel function or a different function applied to the key and query in question.

Similarly, for outputting the output matrix at block 210, the values module 108, in some cases, can treat the value vectors associated with keys that were not identified by the search as though the value vectors evaluate to a constant vector; and can determine output vectors based on this assumption. In some cases, the value of the constant vector may be fixed. In other cases, the value of this constant vector can be determined, for example, by sampling a subset of value vectors at random either independently of the search or based on the search results. In other cases, the determination can include sampling a subset of value vectors based on the subset of keys that were sampled at block 208, and each value vector can be combined by averaging, for example. The values module 108 may also treat the value vectors associated with different keys that were not identified differently, for example by treating each as if it is a different constant vector. The value of this constant vector may be based on a function applied to the associated key, value vector and/or query.

In some cases, such as when the values are value vectors, performance of block 210 can be omitted because the output matrix consists of the attention weights.

At block 212, the output module 110 outputs the post-activations (in the case of attention operations, the attention weights), the output matrix (in the case of attention operations, representing the result of the attention operation), or both, to the local data storage 164, database, I/O interface 168, and/or network interface 176.

In a different embodiment, blocks 208 and/or 210 may be done concurrently with block 206, where attention weights and/or output vectors are determined as new keys are identified in block 206.

An example of search performed by the search module 106 includes processing one or more items within the set of items to search over in some way and using the results of the processing to decide which items to process next or to stop the search. It may process the items sequentially or in parallel. It does not necessarily have to process all items in the same way, or process the same set of items in the same way every time.

Unlike other approaches that identify keys with a k-nearest neighbour search, the present method 200 advantageously does not require the keys to be normalized; and thus, does not require model retraining with such constraints. As proved herein, the present inventors determined that, advantageously, that the k-nearest neighbour search on the higher-dimensional embeddings of the keys and queries (also known as transformed keys and transformed queries) is equivalent to determining the k keys that attain the highest inner products with the query.

Since the attention weight matrix is sparse, the system 100 can combine the values associated keys with high attention weights. Where the challenge is to identify which keys have high attention weights without computing the attention weights of all keys. The observation that the attention matrix of the self-attention mechanism is sparse leads to the determination of how to identify the keys that receive high attention weights from each query in the attention weight matrix. Observe that:

$$arg {max}_{j} {a}_{i , j} = arg {max}_{j} \frac{{s}_{i , j} exp ( \frac{k ( {q}_{i} , {k}_{j} )}{\sqrt{d}} )}{{\sum }_{j ′ = 1}^{m} {s}_{i , j ′} exp ( \frac{k ( {q}_{i} , {k}_{j ′} )}{\sqrt{d}} )} \qquad ( 3 )$$

$$= arg {max}_{j} {s}_{i , j} exp ( \frac{k ( {q}_{i} , {k}_{j} )}{\sqrt{d}} ) \qquad ( 4 )$$

$$= arg {max}_{j} exp ( \frac{k ( {q}_{i} , {k}_{j} )}{\sqrt{d}} ) \qquad ( 5 )$$

$$= arg {max}_{j} \frac{k ( {q}_{i} , {k}_{j} )}{\sqrt{d}} \qquad ( 6 )$$

$$= arg {max}_{j} k ( {q}_{i} , {k}_{j} ) \qquad ( 7 )$$

Hence, the key kⱼ that has the highest attention weight is the key that maximizes k(qᵢ, kⱼ). A particular choice for k(.,.) in neural network architectures is

$$k ( {q}_{i} , {k}_{j ′} ) = {q}_{i}^{T} {k}_{j ′} .$$

When ∥kⱼ, ∥₂=1 for all j′:

$$arg {max}_{j} k ( {q}_{i} , {k}_{j} ) = arg {max}_{j} {q}_{i}^{T} {k}_{j} \qquad ( 8 )$$

$$= arg {min}_{j} - 2 {q}_{i}^{T} {k}_{j} \qquad ( 9 )$$

$$= arg {min}_{j} {‖ {q}_{i} ‖}_{2}^{2} - 2 {q}_{i}^{T} {k}_{j} + 1 \qquad ( 10 )$$

$$= arg {min}_{j} {‖ {q}_{i} ‖}_{2}^{2} - 2 {q}_{i}^{T} {k}_{j} + {‖ {k}_{j} ‖}_{2}^{2} \qquad ( 11 )$$

$$= arg {min}_{j} {q}_{i}^{T} {q}_{i} - 2 {q}_{i}^{T} {k}_{j} + {k}_{j}^{T} {k}_{j} \qquad ( 12 )$$

$$= arg {min}_{j} {( {q}_{i} - {k}_{j} )}^{T} ( {q}_{i} - {k}_{j} ) \qquad ( 13 )$$

$$= arg {min}_{j} {‖ {q}_{i} - {k}_{j} ‖}_{2}^{2} \qquad ( 14 )$$

$$= arg {min}_{j} {‖ {q}_{i} - {k}_{j} ‖}_{2} \qquad ( 15 )$$

Therefore, when all the keys are normalized, the key that has the highest attention weight is the one that is the closest to the query. Similarly, the keys that have the k highest attention weights are the ones that are the k closest to the query. Therefore, an efficient, and possibly approximate, k-nearest neighbour search (k-NNS) algorithm can be used to find such keys; where the keys would be the data points and the queries would be the query points for k-NNS. This property can be utilized by, for example, using locality-sensitive hashing (LSH) for k-nearest neighbour search. However, because such property only holds when all the keys are normalized, other approaches, such as Reformer, require this constraint to hold. Therefore, a transformer whose keys are not originally normalized needs to be retrained with the constraint to be compatible with Reformer.

In contrast, the method 200 can identify keys that have high attention weights and can work in general cases; as opposed to only in the cases where the keys are normalized. Below is one example of key and query embedding functions and a proof that k-nearest neighbour search (k-NNS) on the key and query embeddings can identify keys that have the k highest inner products with the query.
Let T_{K}: [symbol] → [symbol] and T_{Q}: [symbol] → [symbol] be defined as follows:

$${T}_{K} ( {k}_{j} ) = [ {k}_{j} / c \sqrt{1 - {‖ {k}_{j} ‖}_{2}^{2} / {c}^{2}} ] \qquad ( 16 )$$

$${T}_{Q} ( {q}_{i} ) = [ {q}_{i} / {‖ {q}_{i} ‖}_{2} 0 ] \qquad ( 17 )$$

where c≥maxⱼ, ∥kⱼ, ∥₂ is the maximum norm among all data points.

$$arg {max}_{j} k ( {q}_{i} , {k}_{j} ) = arg {max}_{j} {q}_{i}^{T} {k}_{j} \qquad ( 18 )$$

$$= arg {min}_{j} - 2 {q}_{i}^{T} {k}_{j} \qquad ( 19 )$$

$$= arg {min}_{j} 2 - 2 {q}_{i}^{T} {k}_{j} / c {‖ {q}_{i} ‖}_{2} \qquad ( 20 )$$

$$= arg {min}_{j} 1 - 2 {q}_{i}^{T} {k}_{j} / c {‖ {q}_{i} ‖}_{2} + 1 \qquad ( 21 )$$

$$= arg {min}_{j} {‖ {q}_{i} ‖}_{2}^{2} / {‖ {q}_{i} ‖}_{2}^{2} - 2 {q}_{i}^{T} {k}_{j} / c {‖ {q}_{i} ‖}_{2} + {‖ {k}_{j} ‖}_{2}^{2} / {c}^{2} + 1 - {‖ {k}_{j} ‖}_{2}^{2} / {c}^{2} \qquad ( 22 )$$

$$= arg {min}_{j} {q}_{i}^{T} {q}_{i} / {‖ {q}_{i} ‖}_{2}^{2} - 2 {q}_{i}^{T} {k}_{j} / c {‖ {q}_{i} ‖}_{2} + {k}_{j}^{T} {k}_{j} / {c}^{2} + 1 - {‖ {k}_{j} ‖}_{2}^{2} / {c}^{2} \qquad ( 23 )$$

$$= arg {{min}_{j} ( {q}_{i} / {‖ {q}_{i} ‖}_{2} - {k}_{j} / c )}^{T} ( {q}_{i} / {‖ {q}_{i} ‖}_{2} - {k}_{j} / c ) + 1 - {‖ {k}_{j} ‖}_{2}^{2} / {c}^{2} \qquad ( 24 )$$

$${= arg {min}_{j} ‖ {q}_{i} / ‖ {q}_{i} {‖}_{2} - {k}_{j} / c ‖}_{2}^{2} + 1 - {‖ {k}_{j} ‖}_{2}^{2} / {c}^{2} \qquad ( 25 )$$

$${= arg {min}_{j} ‖ {q}_{i} / ‖ {q}_{i} {‖}_{2} - {k}_{j} / c ‖}_{2}^{2} + {( 0 - \sqrt{1 - {‖ {k}_{j} ‖}_{2}^{2} / {c}^{2}} )}^{2} \qquad ( 26 )$$

$$= arg {min}_{j} {‖ {T}_{Q} ( {q}_{i} ) - {T}_{K} ( {k}_{j} ) ‖}_{2}^{2} \qquad ( 27 )$$

$$= arg {min}_{j} {‖ {T}_{Q} ( {q}_{i} ) - {T}_{K} ( {k}_{j} ) ‖}_{2} \qquad ( 28 )$$

Hence, the key k that has the highest attention weight is the one whose transformed version T_{K}(kⱼ) is closest to the transformed query T_{Q}(qᵢ). Therefore, an efficient, and possibly approximate, k-nearest neighbour search (k-NNS) can be used to identity keys k; with high attention weights. If the system 100 takes less than O(dm) time for querying with a single point, then if the same set of keys are shared by a large number of queries, this would enable the system 100 to perform attention without iterating over all the keys for every query. Because the method 200 does not impose any constraints on the keys or queries, it can advantageously be used as a drop-in replacement for attention operations in machine learning models, without requiring retraining of the model.

Generally, it is preferable, but not required, for a k-nearest neighbour search algorithm, used for accelerating attention operations, to have several properties, described below.

First, because the attention weights across all keys for a given query must sum up to a constant, typically 1, there must be some keys that have high attention weights, regardless of the query. Yet, some approximate nearest neighbour search algorithms, such as locality-sensitive hashing (LSH), can return no data points for some query; which happens when no data points fall within the same hash bin as the query point. Hence, the k-nearest neighbour search algorithm should be guaranteed to return at least k vectors regardless of the query.

Second, because the keys in a next attention layer depend on output produced by a previous attention layer, which can change for different queries, the data points for k-NNS May change for different inputs to the model. As a result, a new database for k-NNS may need to be constructed every time the model is run on new input. Therefore, the k-nearest neighbour search algorithm should not require a high computational overhead for preprocessing the data. Effectively ruling out algorithms like LSH, which need substantial time to construct sufficiently many hash tables in order to lower the probability of failing to return any data points. Moreover, because the query changes every time the model is run on new input, the preprocessing overhead cannot be amortized over different inputs to the model. As a result, the sum of preprocessing time and query times for all queries against the same set of keys should be less than the time needed by brute force evaluation to achieve this result in acceleration.

Third, in order for the theoretical guarantees of a k-nearest neighbour search algorithm to be applicable to forming theoretical guarantees on the approximation quality of accelerated attention, the guarantee generally will be on the probability that the algorithm returns an exact set of k-nearest neighbours; rather than an approximate set of k-nearest neighbours. Algorithms that provide guarantees on the former are known as exact algorithms, whereas algorithms that only provide guarantees on the latter are known as approximate algorithms. For example, LSH is an approximate NNS algorithm, because with high probability, it is guaranteed to return a near neighbour; i.e., a point that is father away from the query point than the true nearest neighbour by a factor of (1+∈). Unfortunately, missing some of the true k-nearest neighbours could have a large impact on the output of attention, since even though a near neighbour may not be much farther from the query than the nearest neighbour, its value vector could be very different from the value vector of the nearest neighbour. Therefore, in order to provide a greater guarantee of the approximation quality of accelerated attention, the k-nearest neighbour search algorithm should be exact; in that it should be guaranteed to find the exact set of k-nearest neighbours with high probability.

Fourth, because it is common to use attention operations in autoregressive models, e.g., language models, the set of keys expands as more and more words are generated. Since the keys corresponding to previously generated words remain the same through the generation steps, it is generally ideal to avoid preprocessing the previous keys again every time a new word is generated. Hence, the k-nearest neighbour algorithm, in such cases, should support incremental updates to its database, without needing to preprocess the entire database again.

Lastly, the dimensionality of keys and queries in common neural network architectures is typically high, and so a k-nearest neighbour search algorithm should be selected, where possible, that scales to high dimensional settings.

The present inventors have determined that a k-nearest neighbour search algorithm that satisfies most, if not all, of the above properties is a family of algorithms known as Dynamic Continuous Indexing (DCI). However, it is to be understood that the present disclosure is not so limited to DCI and any suitable k-nearest neighbour search algorithms can be used.

Unlike other nearest neighbour search algorithms, DCI is a ranking-based algorithm rather than a bucketing-based algorithm. The latter type of algorithms keeps track of which data points fall within each bucket, whose boundaries are set before seeing the data points. The former type of algorithms constructs different ways to rank points based on how plausible it is for each to be the true nearest neighbour of the query, and then combines the different rankings together to obtain the final overall ranking of points.

For the purposes of the present disclosure, ranking-based algorithms are generally more appropriate than bucketing-based algorithms because attention weights are sensitive to the relative comparisons between different keys in terms of their similarity to the query; rather than an absolute evaluation of the similarity of each key to the query with respect to a fixed threshold. A bucketing-based algorithm effectively has a fixed threshold on similarity, and so a variable number (including zero) of data points can meet the threshold. On the other hand, a ranking-based algorithm returns a fixed number of data points, which effectively amounts to choosing a variable threshold on similarity based on the data. The latter is better aligned with how attention weights are generally calculated and should yield a better approximation for attention operations.

In a particular case of the method 200, Prioritized DCI can be used, which is an exact k-nearest neighbour search algorithm in the family of DCI-based algorithms. Prioritized DCI has two stages, a data preprocessing stage to preprocess the data points and construct the data structure, and a querying stage to answer k-nearest neighbour queries. At the data preprocessing stage, Prioritized DCI first projects the data points along multiple random directions, sorts the projections along each direction (which are scalars) from least to greatest, and stores both the sorted projections and the projection directions. At the querying stage, Prioritized DCI projects the query along the same projection directions used for preprocessing, and visits data points in the order of proximity to the query along each projection direction. Prioritized DCI alternates between processing different projection directions, though generally not in a fixed order. After visiting a point along a projection direction, the next projection direction Prioritized DCI processes is the projection direction with an unvisited point whose distance to the query along that direction is the smallest. A data point may be visited multiple times along different projection directions. When a data point has been visited along all projection directions, it is considered a candidate for a true k-nearest neighbour. When there are enough candidates, Prioritized DCI returns the k candidates that are the closest to the query.

In some cases, a variant of Prioritized DCI can be used in place of standard Prioritized DCI. The variant can differ from standard Prioritized DCI in that at the querying stage, instead of visiting one data point at a time, it visits multiple data points at a time in sequence or in parallel. These data points may be the closest unvisited data points to the query along a given projection direction, or the closest unvisited data points to the query along multiple projection directions. In the former case, it does not switch to processing a different projection direction until all data points that it would like to visit in one go have been visited.

If the number of random projection directions p is less than an intrinsic dimensionality of the data d′ (which is assumed to be at least 1), Prioritized DCI can return the exact k-nearest neighbours for a query with high probability within Õ(dk^{p/\tilde{d}}m^{1-p/\tilde{d}}+pk^{1/\tilde{d}}m^{1-1/\tilde{d}}) time, where Õ(·) suppresses log factors. The preprocessing used in Prioritized DCI is lightweight, and so it only needs O(dpm) time. The total time required to compute the attention weights is therefore Õ(dpm+dk^{p/\tilde{d}}m^{1-p/\tilde{d}}n+pk^{1/\tilde{d}}m^{1-1/\tilde{d}}n). If one were to compare this to the computational complexity of the attention of O(dmn), it can be observed that there is no longer a term that depends on mn, and so there is no longer the quadratic dependence on context length. Since d and n are typically large, the middle term usually dominates. If a large number of projection directions p relative to the intrinsic dimensionality d and a small number of nearest neighbours to look for k are selected, then the middle term Õ(dk^{p/\tilde{d}}m^{1-p/\tilde{d}}n) will be substantially less than O(dmn); thereby leading to a significant computational speedup.

The approach of method 200 for accelerating attention can be informally thought of as consisting of two phases. In a first phase, the keys k; and queries qᵢ are transformed using Equations (16) and (17), respectively. The keys that are not masked out (i.e., s_{i,j}=1) are added to a database and k-nearest neighbour search (e.g., Prioritized DCI) is performed. The k-nearest neighbours for each transformed query T_{Q}(qᵢ) are determined and the search returns the indices of k nearest transformed keys T_{K} (kⱼ) to each transformed query T_{Q}(qᵢ) and their Euclidean distances to the transformed query ∥T_{K}(kⱼ)−T_{Q}(qᵢ)∥₂. From the Euclidean distance, the inner product can be determined using Equation (20); i.e.,

$$\vert \vert {T}_{K} ( {k}_{j} ) - {T}_{Q} ( {q}_{i} ) {\vert \vert}_{2}^{2} = 2 - 2 {q}_{i}^{T} {k}_{j} / c \vert \vert {q}_{i} {\vert \vert}_{2} .$$

In some cases, different sets of keys may be masked out for different queries. In these cases, usually only the keys that are always masked out are not added to the database; where all the other keys are added. A variant of such cases can be to partition keys into subsets, and then add each subset of keys to a separate database. In both cases, the masking information (whether or not a key is masked out for the current query) may be stored in the database together with keys and value vectors. When querying, search can be conducted only over the keys that are not masked out, and terminated early when there is no longer any more promising keys that are not masked out. Note that even though both cases are presented in the context of different keys being masked out for different queries, both can be used in other settings; for example, when the same keys are masked for all queries, when no keys are masked out, or when masks are not provided as input. For example, when the k-nearest neighbour search algorithm is Hierarchical DCI, the search may be terminated early if there are no unmasked keys in the cells that remain to be searched.

The k-nearest neighbours returned by the search can then be used to efficiently determine O. The naïve approach would be to construct an approximation of A whose entries are all zero except for the k-nearest neighbours. Then, Equation (2) can be used to determine O using the approximation of A. However, this approach is generally slow because executing Equation (2) naïvely takes O(d′mn) time. Instead, in some cases, the system 100 can determine an approximation of the attention weights ã_{i,j} for all j∈S_{kNN}(T_{Q}(qᵢ)) from only the k-nearest neighbours using the following:

$${\tilde{a}}_{i , j} = \frac{exp ( {q}_{i}^{T} {k}_{j} / \sqrt{d} )}{{\sum }_{j ′ ∈ {S}_{kNN} ( {T}_{Q} ( {q}_{i} ) )} exp ( {q}_{i}^{T} {k}_{j ′} / \sqrt{d} )} := {Softmax}_{j} ( {\{ \frac{{q}_{i}^{T} {k}_{j ′}}{\sqrt{d}} \}}_{j ′ = 1}^{m} ) \qquad ( 29 )$$

where S_{kNN} (T_{Q}(qᵢ)) denotes the indices of points in the set of k-nearest neighbours. ã_{i,j}'s can be used to linearly combine value vectors associated with the k closest keys using the following:

$${\tilde{o}}_{i} = {\sum }_{j ∈ {S}_{kNN}} {\tilde{a}}_{i , j} {v}_{j} \qquad ( 30 )$$

In some cases, the system 100 can use a modified Prioritized DCI, which can be informally referred to as ‘Hierarchical DCI’. Hierarchical DCI involves constructing a hierarchy of subsets of data points and applying Prioritized DCI to each level of the hierarchy recursively. More specifically, the bottom level of the hierarchy consists of all data points, where some of the data points are selected for promotion to the next level. Each data point at a given level is assigned a parent, which is a data point at the next highest level, and the parent is the closest higher-level point to the lower-level data point; this is itself a 1-nearest neighbour search problem and can be found using Hierarchical DCI. The set of data points that share the same parent are referred to as a cell. When querying, the system 100 starts the top level and finds the k-closest top-level points to the query using Prioritized DCI, and then performs Prioritized DCI on the cells (consisting of points at the next lowest level) associated with these k points. The k closest points in these cells to the query are obtained, and Prioritized DCI is run on the cells associated with these points, and so on.

Hierarchical DCI may select data points for promotion to the next level according to a deterministic rule, select data points for promotion randomly among a larger set of data points selected according to a deterministic rule, or select data points for promotion according to a deterministic rule among a large set of data points selected randomly. The deterministic rule may be based on information derived from the value of the data points, their identifiers, the sequential order in which they are added, and/or the number of other points that were added and/or removed before the data points in question are added.

In some other cases, Hierarchical DCI may assign each data point to multiple parents and/or multiple levels.

The approach Hierarchical DCI uses to construct a hierarchy of subsets of data points and apply a search algorithm, which in this particular case is Prioritized DCI, to each level of the hierarchy recursively can be used for other search algorithms. Algorithms for k-nearest neighbour search can be used in contexts beyond attention, including but not limited to vector databases, associative memory, collaborative filtering, clustering, vector quantization, classification, retrieval augmented generation (RAG), detection of near-duplicates, interpolation, computational geometry applications, information retrieval applications such as search engines, recommendation systems, etc.

Unlike other approaches, the method 200 does not require the keys and the queries to be shared. Such a constraint is generally needed by other approaches because locality-sensitive hashing (LSH) for k-nearest neighbour search is used; which works by partitioning the vector space into cells/hash bins, keeping track of which keys and queries fall within each cell/bin, and returning the keys that fall within the cell/bin containing the query. If keys and queries are not shared, no keys may be within the cell/bin containing the query. To reduce the probability of this happening, a common workaround used by LSH is to create multiple hash tables and return all keys that fall within all cells/bins across all hash tables containing the query. However, this is impractical for speeding up attention operations because doing so costs substantial time in constructing the hash tables; which typically needs to be performed from scratch each time attention is performed, since the keys and queries can change every time. Consequently, other approaches generally resort to requiring the keys and queries to be shared, which guarantees that at least one key lies in the cell/bin containing the query (namely itself).

The method 200 avoids the above substantial problem by, in some cases, using Dynamic Continuous Indexing (DCI) for the k-nearest neighbour search. Unlike LSH, DCI does not partition the vector space, and thus, can always return any desired number of keys for each query. Moreover, DCI does not impose a heavy preprocessing overhead and can construct data structures efficiently. This allows the system 100 to eliminate the constraint of sharing keys and queries, and hence, the requirement for retraining the model with this constraint. Moreover, whereas other approaches may only be applicable to self-attention because sharing the keys and queries requires the number of keys and queries to be the same, the method 200 is applicable to any type of attention operation.

The method 200 can also be applicable to other ways of defining attention weights, such as replacing a softmax layer with a sparsemax or other activation function. The method 200 can also be used to speed up computation of softmax, sparsemax, and other activation functions outside the context of attention. For these other ways of defining attention weights, instead of applying the softmax to the subset of the keys identified by the search algorithm, generally the method 200 would apply the sparsemax to those keys. The method 200 is generally applicable to the sparsemax because both the softmax and the sparsemax preserve the relative ordering of the different components of the input vector. To approximate the sparsemax, the system 100 can identify the keys that result in the highest similarity score, calculating the attention weights given by the sparsemax on those keys, and setting the attention weights on keys other than those keys to zero. There would be substantial computation gains in efficiency because the rapid identification of keys that will receive high similarity scores identified by the search.

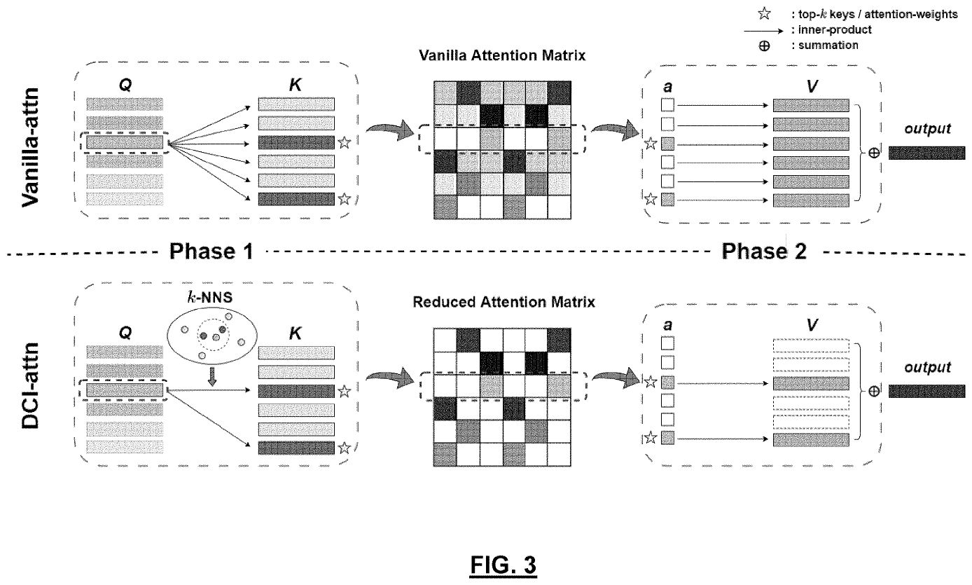

FIG. 3 illustrates an example implementation of a prior approach to attention operations, referred to as ‘Vanilla-atten’ (top row), and the attention operation of the method 200, referred to as ‘DCI-atten’ (bottom row). This example is illustrated using one query and k=2 in k-NNS. In the two attention matrices presented, the top-2 largest attention weights in each row are represented by a dark shade. The remaining attention weights are shown in a paler shade in the vanilla attention matrix, and are set to zero (depicted in white) in the attention weight matrix for the accelerated attention operation.

The present inventors conducted example experiments, using the method 200, on a lonxg range arena (LRA) benchmark. This benchmark comprises five tasks that require learning long-range dependencies. Across all five tasks, the method 200 demonstrated greatly improved performance during inference, when provided with well-trained weights, in comparison to five different baseline models. Notably, the method 200 not only achieved accuracy that was close to that obtained using a vanilla transformer, but also surpasses the efficiency of all baseline approaches.

The performance of the system 100 was tested on five tasks from the Long Range Arena (LRA) benchmark: parsing, document retrieval, text classification, image classification, and path finding. These tasks consist of sequences ranging from 1000 to 5000 tokens, including various data types such as text, natural and synthetic images, and mathematical expressions.

A first task, ListOps, was a sequence of summary operations on single digit integers which are in the prefix arithmetic style. The model aims to predict a single-digit integer in a ten-way classification. In the example experiments, the dataset was generated using tools from the LRA benchmark, with maximum sequence length of 4000. A second task, text classification, was based on a dataset of movie reviews, and was aimed at binary classification. The dataset was taken directly from the LRA benchmark with maximum sequence length of 4000. A third task, document retrieval, was based on related article matching from the ACL anthology network. The dataset was taken directly from LRA benchmark with maximum sequence length of 4000. A fourth task, image classification, was aimed at classifying the type of object in an image presented as a sequence of grayscale values. The dataset was taken directly from LRA benchmark with maximum sequence length of 4000. A fifth task, Pathfinder, was aimed at predicting whether two points in an image are connected by a path or not. The dataset was taken directly from LRA benchmark with maximum sequence length of 4000.

For all tasks, vanilla transformer models were used as baseline models. For each task, the baseline models were trained. Then, the example experiments applied the DCI-atten, of the present embodiments, to the baseline models during inference. The performance of the system 100 was compared with the vanilla self-attention in two aspects: prediction accuracy and running time.

For each of these tasks, it was evidenced that the present embodiments were able to substantially accelerate the inference and training time of the transformers and reduce its memory-cost.

For ease of reference, the present embodiments generally refer to acceleration of an attention operation, however it is understood that the approach of the present embodiments can be used to accelerate the operation of any suitable layer in the machine learning model. For example, the present approaches used for the accelerating the attention operation can be likewise used to accelerate the evaluation of a softmax, sparsemax or logistic layer in a classifier model, or a linear or convolutional layer with a rectified linear activation function (ReLU) or softplus activation in an artificial neural network, or the like. In this way, the attention weights described herein are functionally equivalent to post-activations, the queries described herein are functionally equivalent to the input vector, the keys described herein are functionally equivalent to rows of the weight matrix if the weight matrix is left-multiplied to the input vector, or columns of the weight matrix if the weight matrix is right-multiplied to the input vector, and the values described herein are functionally equivalent to value vectors. If the layer's weight matrix is not directly multiplied to the input vector, e.g., in the case of convolutional layers, it is often possible to transform the weight matrix such that the mathematical operation performed is equivalent to multiplying the transformed weight matrix by the input vector. In this case, the approach described herein applies with the transformed weight matrix in place of the weight matrix. For layers with an activation functions map that is an m-dimensional vector space to a m−1-dimensional simplex, such as in the case of a softmax, sparsemax or logistic layer, post-activations are often referred to as class probabilities. Because the values are columns of the identity matrix, step 210 may not have to be performed explicitly, since the output matrix is identical to the attention weights.

The same or similar mechanism used for the accelerated attention operation performed by the system 100 can be also used to accelerate querying in vector databases, which associate each item stored in the database with a key vector and answer similarity queries by identifying key vectors that are similar or near a query vector, whether the measure of similarity and distance is defined by a kernel function.

In a particular example application, the attention operation performed by the system 100 can be used for differentiable point rendering of a three-dimensional (3D) scene using proximity attention.

In most cases, an ideal 3D representation of a scene should satisfy some general properties, for example: (1) it should be expressive enough to support high rendering quality, (2) it should be efficient to store and render, (3) it should be easy to manipulate, and (4) it should be easy to reconstruct from captures of the scene with widely available devices, including but not limited to RGB (colour) cameras, RGB-D (colour and depth) cameras or infrared (IR) cameras. Most approaches focus primarily on the first three properties, but less so on the last property. As a result, these types of 3D graphics pipelines do not support easy conversion of captures to 3D assets and require artists to manually construct them. However, attaining the last property has historically generally required sacrificing some of the other properties.

3D representations can be broadly grouped into two categories, volumetric representations and surface representations. Volumetric representations encode information about the scene at each 3D coordinate, whereas surface representations encode scene information at 3D coordinates on the surface of objects only. Some approaches build on volumetric representations and attain properties (1) and (4); such that they can produce high rendering quality and reconstruct the scene representation from images captured from multiple views, for example, by minimizing the difference between rendered images and the captured images with respect to the representation with gradient-based optimization. The ability to successfully reconstruct the scene representation by optimizing with respect to the representation is often referred to as end-to-end learnability. One of the biggest advantages of volumetric representations is that they can be learned end-to-end straightforwardly, because the rendered image changes smoothly as a function of the representation. However, volumetric representations are inefficient for storage and/or rendering. Volumetric representations require cubic growth in storage space to accurately represent the scene in the worst case as the scene diameter increases. In addition, rendering volumetric representations requires volumetric rendering, which needs to sample at multiple points along each ray. Since typical scenes consist of opaque objects and lots of empty space, only the appearance and the geometry of object surfaces need to be stored and only the point where each ray hits the surface needs to be sampled. Therefore, the storage and the rendering of volumetric representations are inefficient relative to minimal storage and sampling requirements.

On the other hand, surface representations generally only require quadratic growth in storage space as the scene diameter increases. This is much more efficient than volumetric representations because it can avoid storing information within empty space and object interiors. Examples of surface representations include polygonal meshes and point clouds that lie on the surface, which can be informally referred to as surface point clouds. To take advantage of the efficiency of surface representations, there is a substantial challenge to overcome; mainly that surface representations are much more difficult to learn end-to-end than volumetric representations since the rendered image does not change continuously as a function of the surface normal. While polygonal meshes model geometry precisely, they are not very expressive, because the topology of the shapes they model cannot change without changing the connectivity between polygon vertices. Allowing modification to the connectivity is non-trivial, because enforcing the validity of the mesh (e.g., planarity, watertightness) is computationally difficult. Embodiments of the present disclosure provide an approach to address the challenge of learning surface point clouds end-to-end from colour image captures from multiple views.

Learning a point cloud end-to-end generally requires a differentiable way of rendering a point cloud. Unfortunately, rendering a point cloud comes with unique and substantial challenges because each point is infinitesimal; thus, a ray rarely intersects with any point. A common approach to get around this fact is to turn points into spheres, discs, or Gaussian kernels. However, choosing an appropriate radius for the spheres/discs, or standard deviation for the Gaussian kernels, is difficult. A small radius or standard deviation would cause the gradient with respect to the point to vanish for distant rays, while a large radius or standard deviation would cause the rendered image to be coarse/blurry. As a result, there is an undesirable trade-off between rendering quality and end-to-end learnability. As a workaround, some approaches keep the point radii small to attain high rendering sharpness, and make up for the vanishing gradients with a very large number of points, often in the order of millions. However, the vanishing gradients prevent a lot of the points from being moved to the surface, leading to a large number of points that are far from the surface, and thereby, cause such approaches to fall short of the representational efficiency that surface point clouds can in principle attain. Other approaches estimate the intersection point of a ray with a surface reconstructed from the point cloud. However, the intersection point of a ray with a surface does not change smoothly as a function of the surface or sampled points from the surface. Moreover, surface reconstruction is ill-posed, in that multiple surface reconstructions are possible that are all consistent with the same point cloud, so estimated intersection points can be inaccurate.

Some computer graphics pipelines extract a mesh surface from the point cloud and find intersections between the rays and the mesh. The mesh extraction operation involves fitting a Signed Distance Function (SDF) from the point cloud by solving the Poisson equation and performing a marching cubes algorithm to obtain the mesh. This extraction process is error-prone, and more critically, it is non-differentiable; thus, it prohibits the gradient from backpropagating to the point cloud.

Embodiments of the present disclosure provide an approach for learning a point cloud end-to-end that avoids the drawbacks of either of the above approaches for rendering point clouds. Instead of having the magnitude of the gradient with respect to a point depend on its absolute distance from the ray, the system 100 makes it depend on its distance from the ray relative to the distance of other points from the ray. Instead of estimating the intersection point directly, the system 100 learns a feature vector for each point and estimates which points' features should be combined to produce the desired colour. The attention operation is used to identify which points a ray should attend to, informally referred to as proximity attention. In proximity attention, each key is a function of ray-dependent point features, which include the displacement from the point to the closest point on the ray. Each query is a function of the ray direction. Each value is a function of the ray-dependent point features and a learned feature vector.

Using the above, the system 100 can learn high-quality point clouds ab initio, unlike other approaches that require initializing the point cloud with another 3D reconstruction algorithm, such as structure from motion (SfM) or multi-view stereo (MVS). Moreover, other system 100 can move points towards the surface over the course of training, resulting in surface point clouds. In example experiments, even with only a few thousand points, the system 100 can attain high rendering quality; whereas other point-based renderers require hundreds of thousands of points to render high-quality images. Moreover, the system 100 can automatically adapt the density of the learned point cloud based on the geometric complexity. The system 100 can also learn feature vectors for each point that capture local geometry and material properties.

The small number of points that the system 100 requires to produce high rendering quality is advantageous for users to manipulate and edit the 3D geometry and scene. Surface continuity is preserved even after applying non-volume preserving transformations; like bending and stretching. In addition, the learned feature vectors allow users to quickly select all points that share the same material and represent surfaces with similar geometry. Users can then manipulate all these points as a whole. Users can copy or remove objects or parts of objects by copying or removing points and associated feature vectors that represent the objects or parts. Finally, users can also copy and/or swap appearance and/or material properties from one part of the 3D scene to another by manipulating the feature vectors of each point based on the feature vectors of other points whose material properties are copied.

Unlike other differentiable rendering approaches that offer users the capability to edit the 3D geometry and scene, the system 100 can be trained on only one unedited 3D scene. In particular, the system 100 does not require being trained on multiple variants of a scene, which differ in a similar way to edits that a user would have the ability to apply.

To copy and/or swap appearance and/or material properties, principal components analysis (PCA) or related approaches, including but limited to independent components analysis (ICA), factor analysis, neighbourhood components analysis (NCA), clustering and autoencoders, can be applied. Such approaches can be applied to the set of feature vectors associated with points whose properties would be copied from (which are informally known as “source points”) and points whose properties would be copied to (which are informally known as “target points”). If PCA is used, the top-k principal components of the target points would be replaced by the top-k principal components of the source points, whereas the coefficients along all principal components can remain the same. In some cases, the coefficients along the non-top-K principal components of the target points are set to zero. If another approach is used, this procedure would apply analogously, by treating basis vectors or basis functions as principal components and the coefficients on the basis vectors or functions as coefficients along the principal components.

Point coordinates and feature vectors for different 3D scenes or variants of the same scene may share parameters or are otherwise related through the training objective, in order to model variations of scenes, scenes with similar objects, or structure and dynamic scenes with moving objects or parts of objects. For example, in scenes with moving objects, the feature vectors of the same object across time may be shared or encouraged to be similar through the training objective, and the point coordinates of the same object may be encouraged to be close to one another across time.

Developed differentiable renderers (DRs) can be used to learn scene representations. A differentiable render [symbol] takes in a scene representation r and a camera pose p as input, and outputs a rendered image [symbol] = [symbol] (r, p). The learning objective is to minimize the loss [symbol] between the rendered image [symbol] and the observed ground truth [symbol] . To learn the scene representation r end-to-end, the differentiability of [symbol] is critical as it allows the gradient backpropagate to r by calculating

$$\frac{\partial ℒ}{\partial r} = \frac{\partial ℒ}{\partial ℱ} \frac{\partial ℱ}{\partial r} .$$

The differentiable renderer [symbol] and the scene representation r can further be parameterized by neural networks and these neural network rendering approaches can produce photo-realistic output renderings.

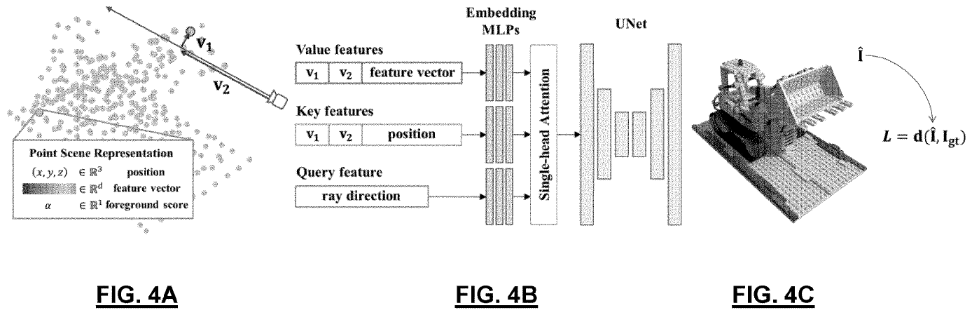

FIGS. 4A to 4C are diagrams showing an overview of an example of an end-to-end learnable point-based rendering pipeline. FIG. 4A shows ray, point features, FIG. 4B shows an attention layer, and FIG. 4C shows a generator.

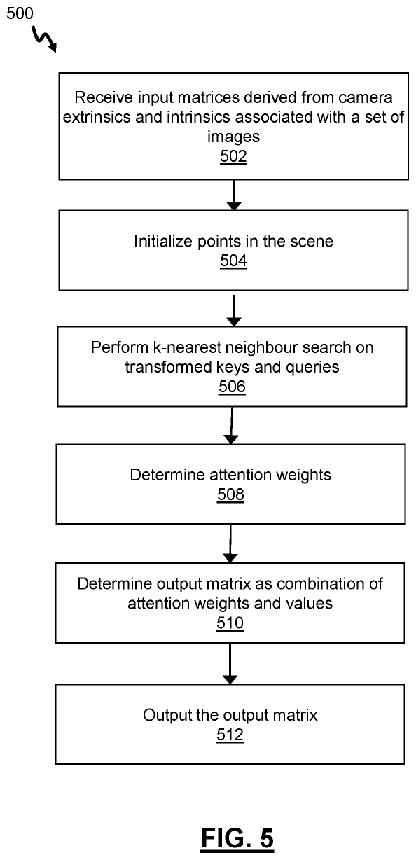

FIG. 5 is a flowchart showing a method 500 for differentiable point rendering using proximity attention to learn representation of a 3D scene, in accordance with an embodiment.

At block 502, the input module 102 receives input matrices derived from camera extrinsics and intrinsics associated with a set of images. The input can be a combination input matrix

$$𝒯 = {\{ ( {I}_{i} , {R}_{i} , {t}_{i} , {K}_{i} ) \}}_{i = 1}^{N}$$

derived from a set of N images, where Iᵢ∈ [symbol] are the RGB images, the Rᵢ∈ [symbol] are camera rotation matrices, the tᵢ∈ [symbol] are camera translation vectors, and the Kᵢ∈ [symbol] are the camera intrinsics. While the present disclosure generally refers to RGB images, it is to be understood that any suitable color model and associated images can be used.

Generally, camera intrinsics refers to information specific to a camera, which does not depend on its position or orientation; for example, the focal length, the width and height of each pixel, and the like. Generally, camera extrinsics refers to information that depends on the position and orientation.

The set of input images are generally capturing the same 3D scene, which is the subject of the reconstruction, and generally captured from multiple positions and angles. In an example, in order to capture the images, multiple cameras can be placed at different positions in a 3D scene and oriented at angles that are directed towards the parts of the 3D scene that are to be reconstructed. In another example, the images can be captured by taking a single camera, or a few cameras, and moving them through a sequence of different positions and orientations.

Generally, the translation vectors characterize the position of each camera relative to some point in the scene, typically defined as the origin. They can be provided, if for example, the respective cameras are installed on a fixed capture rig and calibrated accordingly. In other cases, the translation vectors can be estimated from the images captured by all cameras using Structure from Motion (SfM) algorithms and/or sensor measurements (e.g., accelerometer readings). In an example, the camera positions can be determined by (1) capturing images with a camera at different positions in the scene, (2) performing a Structure from Motion (SfM) approach, such as a COLMAP software package, on the set of captured images (which estimates the camera position and orientation for each image), and (3) outputting the estimated camera positions for all images. Other suitable sequences and approaches are also possible.

Camera intrinsics can be provided by camera specifications or retired from metadata for the captured images. The camera intrinsics can include information like, for example, the focal length, and the width and height of each pixel. Camera intrinsics can also be estimated with a Structure from Motion (SfM) software package like COLMAP. In an example, camera intrinsics can be determined by: (1) capturing images with a camera at different positions in the scene, (2) performing a Structure from Motion (SfM) approach, such as a COLMAP software package, on the set of captured images (which estimates the camera position and orientation for each image), and (3) outputting the estimated camera intrinsics for all images.

The scene can be represented as a set of points,

$$𝒫 = {\{ ( {p}_{j} , {f}_{j} ) \}}_{j = 1}^{M}$$

of M points, with learned position pⱼ∈ [symbol] and neural feature vector fⱼ∈ [symbol] .

At block 504, the initialization module 112 can initialize the points; for example, points randomly distributed in a cube. Points generally are to be initialized because point coordinates are updated iteratively and the change at each iteration is generally small and incremental. Any suitable initialization approach can be used, either uninformatively or informatively. Uninformative initialization does not incorporate any knowledge about scene geometry and camera layout in determining how to initialize, and can include random initialization of points distributed on a sphere or any other arbitrary geometric shape. Informative initialization can incorporate knowledge about scene geometry and camera layout, such as points uniformly distributed in the convex hull of visible parts of the space, points reconstructed by Structure from Motion (SfM) algorithms or other algorithms, points acquired through real-world depth sensors such as LiDAR.

In another case, at block 504, the initialization module 112 can initialize both the points and the neural feature vectors from the associated points and neural feature vectors of a machine learning model previously trained with the method 500 or another similar method on either the current scene or a different scene.

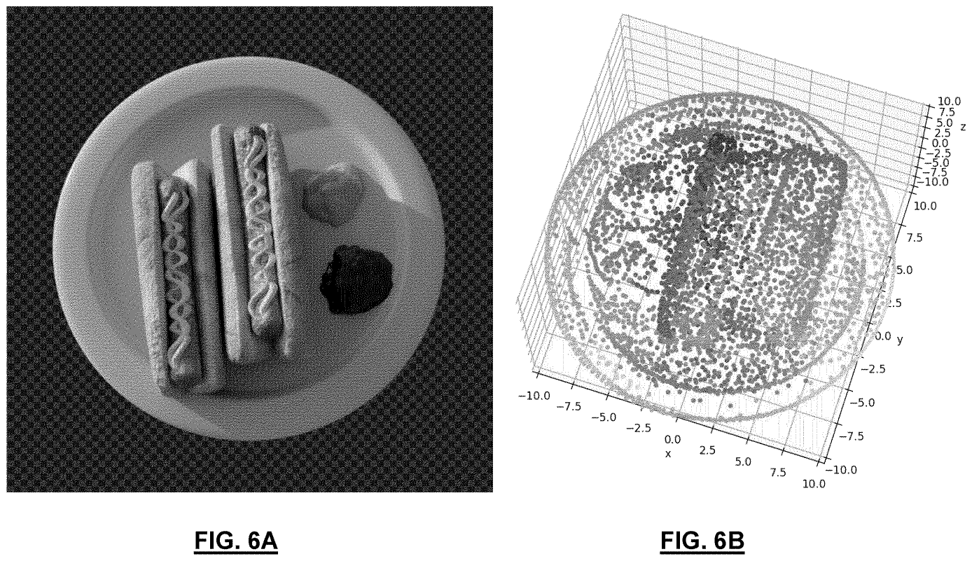

A neural feature vector fⱼ encodes local scene properties at pⱼ, such as local geometry and material properties. Both pⱼ and fⱼ are optimized end-to-end during training. An example of the learned point coordinates and features is shown in FIGS. 6A and 6B, where FIG. 6A shows the reference scene and FIG. 6B shows the associated point cloud. FIGS. 6A and 6B show an example visualization of the learned point coordinates

$${\{ {p}_{j} \}}_{j = 1}^{M}$$

and features

$${\{ {f}_{j} \}}_{j = 1}^{M}$$

on a scene with two hotdogs. In this example, the dimensionality of the features

$${\{ {f}_{j} \}}_{j = 1}^{M}$$

are reduced to 3 with t-SNE for visualization purposes.

Generally, fⱼ and pⱼ are variables that are maintained throughout training, and can be iteratively updated, together with the model weights, during training. These variables can, in some cases, be randomly initialized to some arbitrary values. Then, during training, both variables can be updated, for example with a gradient-based optimization algorithm, together with the weights of the machine learning model. While training, the machine learning model generally aims to render the 3D scene representation (which consists of the learned point coordinates and feature vectors) from a camera associated with a training image such that it minimizes the difference between the rendering and the training image. To minimize such difference, the system 100 determines the gradient of this difference with respect to the model weights, the point coordinates, and the feature vectors, and the system 100 updates the variables with a function of the gradient. Each of these updates can be an iterative update. In another case, some or all of the point coordinates or neural feature vectors are outputs of functions of other inputs, such as the point coordinates of other points, the point coordinates at the previous frame in a temporal sequence of 3D scenes or the parameters of a parametric model of a shape category. In this case, rather than directly updating the outputs of these functions, the parameters of the functions are updated.

In the method 500, the cumulative effect of the small iterative updates can result in a set of point coordinates (referred to as a “point cloud”) that advantageously corresponds to the true geometry of the 3D scene; even if the point coordinates are initialized in a completely uninformed way. In this way, the method 500 can be referred to as “end-to-end learnable”. In contrast, other approaches generally cannot learn the correct point cloud if the point cloud is initialized in an uninformed way, and generally require that the point cloud to be initialized in an informed way in order to arrive at a point cloud with a reasonable configuration; such approach generally requires prior knowledge of the scene geometry and/or camera layout.

The point coordinates or neural feature vectors may be modified before rendering the 3D scene. This can result in the rendering of a modified scene whose geometry and appearance reflect the modified point coordinates or neural feature vectors. The present inventors have observed that modifying the point coordinates can lead to modified geometry and modifying neural feature vectors can lead to modified appearance. The modifications can be performed by the user or by an algorithm. As an example of both the former and the latter, the user can modify the coordinates of some points and the coordinates of other points can be automatically computed based on the user-modified coordinates and the original coordinates of all points. As an example of the latter, the point coordinates and neural feature vectors can be optimized using method 500 on a different 3D scene with some or all of the weights of the model frozen. As another example of the latter, the point coordinates can be processed by an algorithm to yield another set of point coordinates with desirable properties, such as smoothness or local rigidity. Different modifications can be composed together. Modifying the point coordinates or neural feature vectors can be uses for geometry editing, texture editing, texture transfer, 3D scene interpolation, interpolation editing, 3D motion estimation, motion editing, animation, etc.

At block 506, the extraction module 114 extracts ray-to-point features, which allow end-to-end learning of a point cloud ab initio.

For each pixel in the image captured by the ith camera Iᵢ, a ray r_{i,k}:=[O_{i,k} d_{i,k}] is casted, where k∈{1, . . . , HW} is defined by its origin o_{i,k}∈ [symbol] and viewing direction d_{i,k}∈ [symbol] as a unit vector in world coordinates, obtained from a pinhole camera model defined by (Rᵢ, tᵢ, Kᵢ). However, any suitable camera model can be used. For a ray-point pair (r_{i,k}, pⱼ), the extraction module 114 finds a projection

$${p}_{j}^{′}$$

of pⱼ on the ray r_{i,k}:

$${p}_{j}^{′} = {o}_{i , k} + 〈 {p}_{j} - {o}_{i , k} , {d}_{i , k} 〉 \cdot {d}_{i , k} \qquad ( 31 )$$

The extraction module 114 determines a displacement from

$${p}_{j}^{′}$$

to pⱼ and a displacement from o_{i,k} to

$${p}_{j}^{′}$$

using:

$${s}_{{1}_{i , k , j}} = {p}_{j} - {p}_{j}^{′} , {s}_{{2}_{i , k , j}} = {p}_{j}^{′} - {o}_{i , k} \qquad ( 32 )$$

where

$${s}_{{1}_{i , k , j}} and {s}_{{2}_{i , k , j}}$$

as the ray-to-point features.

At block 508, an attention module 116 aggregates the ray-to-point features and learns surface-ray intersections.

For each r_{i,k}, the attention module 116 selects a set [symbol] of K points from [symbol] that are in some way close to the ray. The criterion used to select the points can be: the smallest orthogonal distance

$${‖ {s}_{{1}_{i , k , j}} ‖}_{2}$$

between points and the ray, the smallest projected distance to the ray along the image plane of the camera the ray is cast from, the smallest projected distance to the ray along the image plane of another real or virtual camera, or the smallest or largest value of a function of

$${s}_{{1}_{i , k , j}} and {s}_{{2}_{i , k , j}} .$$

The displacements

$${s}_{{1}_{i , k , j}} and {s}_{{2}_{i , k j}} ,$$

as well as pⱼ∈ [symbol] _{i,k} can be transformed using a positional encoding γ(s)=[sin (2⁰πs), cos (2⁰πs), . . . , sin (2^{T} πs), cos (2^{T} πs)] to learn high-frequency functions in low-dimensional problem domains. In another case,

$${s}_{{1}_{i , k , j}} and {s}_{{2}_{i , k , j}}$$

can be normalized before being transformed using a positional encoding. In another case, a norm of

$${s}_{{1}_{i , k , j}} and {s}_{{2}_{i , k , j}}$$

can be computed before being transformed using a positional encoding. In another case, a function of

$${s}_{{1}_{i , k j}} or {s}_{{2}_{i , k j}}$$

can be evaluated before being transformed using a positional encoding. The descriptor of value vector V_{i,k,j}, the descriptor of the key vector K_{i,k,j}, and the descriptor of the query vector Q_{i,k} can each be a concatenation of one or more of the following (though V_{i,k,j}, K_{i,k,j} and Q_{i,k} can be concatenations of different subsets of the following): a constant scalar or vector, the displacement

$${s}_{{1}_{i , k , j} ,}$$

the displacement

$${s}_{{2}_{i , k j}} ,$$

a normalized displacement

$${s}_{{1}_{i , k j}} / ‖ {s}_{{1}_{i , k j}} ‖ ,$$

a normalized displacement

$${s}_{{2}_{i , k j}} / ‖ {s}_{{2}_{i , k j}} ‖ ,$$

a norm of the displacement

$$‖ {s}_{{1}_{i , k , j}} ‖ ,$$

a norm of the displacement

$$‖ {s}_{{2}_{i , k j}} ‖ ,$$

a function of the displacement

$${s}_{{1}_{i , k j}}$$

and its norm, a function of the displacement

$${S}_{{2}_{i , k , j}}$$

and its norm, and/or the positional encoding of any of the previous quantities. Where the norm ∥·∥ is used, it is understood that any norm can be used. The descriptor of the value vector V_{i,k,j} can also include in its concatenation neural feature vector fⱼ∈ [symbol] _{i,k}. The descriptor of the key vector K_{i,k,j} can also include in its concatenation the point position pⱼ, a scaled point position cpⱼ for some constant c, a normalized point position pⱼ/∥pⱼ∥, a function of the point position and its norm, and/or the positional encoding of any of the previous quantities. The descriptor of the query vector Q_{i,k} can also include in its concatenation the ray direction d_{i,k}, a scaled ray direction cd_{i,k} for some constant c, a function of the ray direction, and/or the positional encoding of any of the previous quantities. It is understood that any suitable positional encoding can be used; for example, other basis functions including but not limited to wavelets, polynomials, splines, spherical harmonics, radial basis functions, etc. can be used in place of, or in addition to, the sins and cosines in the positional encoding.

In a particular case, the attention module 116 can pass the descriptors through three multilayer perceptrons (MLPs) or neural networks with other architectures and providing the output of the MLPs to the attention layer. This approach can be formulated as:

$${\tilde{V}}_{i , k , j} = {F}_{{θ}_{V}} ( {V}_{i , k , j} ) \qquad ( 33 )$$

$${\tilde{K}}_{i , k , j} = {F}_{{θ}_{K}} ( {K}_{i , k , j} ) \qquad ( 34 )$$

$${\tilde{Q}}_{i , k} = {F}_{{θ}_{Q}} ( {Q}_{i , k} ) \qquad ( 35 )$$

A single layer of a single-head attention layer can be used to aggregate a feature code f_{i,k}∈ [symbol] for ray r_{i,k}. In one embodiment, the following formula can be used to determine the attention weights and outputs:

$${w}_{i , k , j} = softmax ( {max}_{} ( \frac{〈 {\tilde{Q}}_{i , k} , {\tilde{K}}_{i , k j} 〉}{\sqrt{d}} , 0 ) ) \qquad ( 36 )$$

$${f}_{i , k} = {w}_{i , k , j} ⊙ {\tilde{V}}_{i , k , j} \qquad ( 37 )$$

Where d is the dimension of keys and queries, W^{Q}, W^{K} and W^{V} are learnable projection matrices, and w_{i,k} is the attention weight vector where each entry corresponds to a point pⱼ and w_{i,k,j} is the jth element of w_{i,k}; the larger the attention weight is, the more ray r_{i,k} will attend to pⱼ. The ⊙ denotes element-wise multiplication. Aggregating f_{i,k} for all the rays r_{i,k} corresponding to Iᵢ gives a feature map Fᵢ∈ [symbol] .

In further cases, the attention module 116 can be accelerated using the method 200 using the functions performed by the embedding module 104, the search module 106, and the values module 108.

At block 510, a generator module 118 may use a convolutional generator to generate an RGB prediction given the feature map. The generator module 118 converts the 2D feature map Fᵢ into the RGB prediction Îᵢ with a 2D convolutional neural network (CNN). In an example, a U-Net CNN, with two down-sampling layers and two up-sampling layers, can be used. In some cases, BatchNorm layers that are usually in U-Net can be removed because a batch size equal to one can be used during training. In other cases, any suitable neural network architecture can be used in place of the U-Net. In other cases, any suitable function can be used in place of the U-Net, including but not limited to, a lookup table or a retrieval mechanism from a database, e.g., nearest neighbour search or an interpolator. In other cases, the U-Net can be removed altogether. Moreover, the generator module 118 may generate a depth prediction given the attention weights. To do so, for every ray, it can compute a weighted sum of distances from the camera centre to different points, projected distances from the camera centre to different points projected along the camera's optical axis or some other notion of distances, where the weights are the attention weights for the given ray.

In another case, the neural feature vector fⱼ can have different dimensions dedicated to reconstructing different modalities, such as RGB, depth, intrinsic images, infrared (IR) etc. In this case, the generator module 118 converts different sets of channels of the 2D feature map Fᵢ into predictions in different modalities.

The RGB image is a rendering of the representation of the 3D scene; where given the camera extrinsics and camera intrinsics, an RGB image can be determined that corresponds to a viewpoint of the 3D scene corresponding to the respective camera. The conversion from the 3D scene representation to an RGB image can be referred to as “rendering” and performed by casting rays in different directions from the camera, each of which corresponds to a pixel in the RGB image. For each ray, the proximity attention operation is performed, which outputs attention weights for each point in the 3D representation. The attention weights are then used to aggregate the feature vectors associated with the points. Since each ray results in one set of attention weights, such ray is associated with one aggregated feature vector. The different feature vectors for different rays can be arranged in a grid, which yields the 2D feature map Fᵢ-Since each ray corresponds to a pixel in the image, the 2D feature map can have the same width and height as the RGB image to be rendered, and in this way, the 2D feature map is a representation of the RGB image.

At block 512, the output module 110 outputs the RGB prediction as a representation of the 3D scene.

Given a target RGB image Iᵢ, the method 500 performs training by minimizing a loss that may include a term that is a distance between the target RGB image Iᵢ and the RGB prediction Îᵢ. The distance can be a variety of distance functions which attain their minima when the target is identical to the prediction. Moreover, the loss may include other terms such as regularizers, such as those that encourage smoothness or local rigidity of the point cloud, or additional loss terms if other forms of supervision are available, such as depth maps, intrinsic images, infrared (IR) images, etc. In this case, the loss terms can be distances between the target and the prediction in each modality, i.e., depth maps, intrinsic images, infrared (IR) images, etc., or distances between a function of the targets and the predictions in different modalities, e.g., shading, which is the quotient of the original image in linear colour space to the intrinsic image.

In some cases, to learn a denser and more precise point cloud, a point pruning and adding strategy can be used. In such cases, points can be pruned based on a learnable foreground score vector cⱼ, j∈{1 . . . M}, which can be jointly optimized with point coordinates and neural feature vectors during training. For example, when a foreground score vector or confidence vector is present, the vector can be maintained as a separate variable that can be learned together with the point coordinates, point features, and the neural network weights. After the foreground score vector is learned, points whose foreground scores is below a threshold can be pruned.

In some cases, the point coordinates or neural feature vectors can be updated in between regular updates made by an optimization algorithm. For example, the point coordinates can be updated to better conform to a geometric prior, such as local rigidity of deformations relative to another 3D scene.

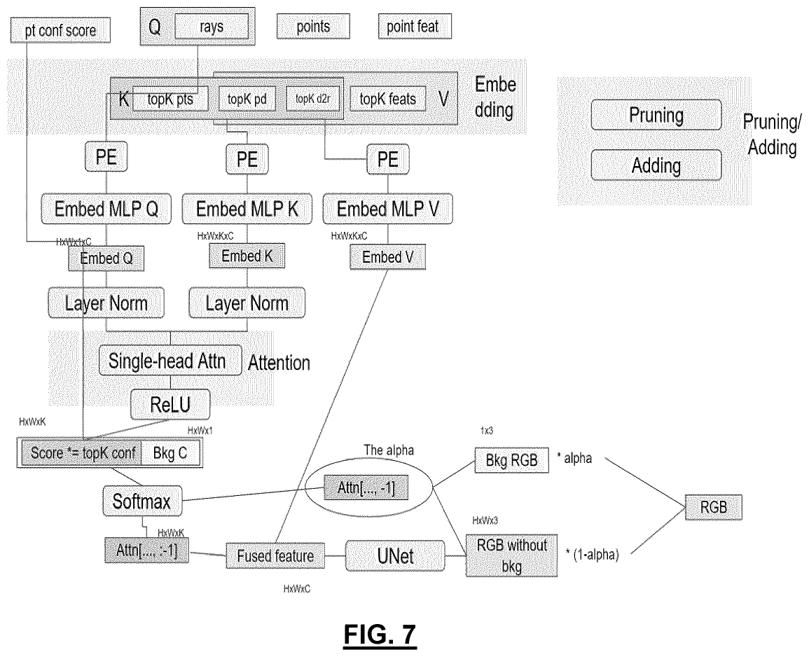

FIG. 7 illustrates an example diagram of a neural network architecture for performing at least portions of the method 500.

The present inventors conducted example experiments to verify the advantages of the method 500. The example experiments included comparing the method 500 to other point-based neural rendering methods, namely neural point-based graphics (NPBG), differentiable point-based radiance fields (DPBRF), sculpted neural points (SNP), and point-based Neural Radiance Fields (Point-NeRF). The example experiments also included ana analysis of the potential broader impact of the method 500 by comparing it to the implicit volumetric representation method NeRF. For the method 500, the example experiments used a total of 30,000 points in the scene representation. To ensure a fair comparison, the number of points used by each baseline method was matched, if they originally used a smaller number. Moreover, the parameter K=20 was set for selecting the top nearest points, and the point feature vector dimension h=64. The performance of all methods in both synthetic and real-world scenarios were evaluated. For the synthetic setting, the NeRF Synthetic dataset was used, while for the real-world setting, a Tanks & Temples dataset was used. The example experiments evaluated the generated image quality using peak signal-to-noise ratio (PSNR), structural similarity index measure (SSIM), and, a perceptual quality metric, the learned perceptual image patch similarity (LPIPS).

TABLE 2

| | NeRF Synthetic | | | | Tank & Temples | | | | |
|---|---|---|---|---|---|---|---|---|---|
| | PSNR ↑ | SSIM ↑ | LPIPS_{vgg} ↓ | # of points | PSNR ↑ | SSIM ↑ | LPIPS_{vgg} ↓ | # of points | Initialization |
| NeRF | 31.00 | 0.947 | 0.081 | — | 28.32 | 0.904 | 0.168 | — | — |
| NPBG | 24.56 | 0.923 | 0.109 | >1M | 25.97 | 0.889 | 0.137 | >1M | SfM |
| DPBRF | 27.37 | 0.914 | 0.101 | 45K | — | — | — | 45K | Visual |
| | | | | | | | | | Hull |
| SNP | 27.47 | 0.939 | 0.067 | 500K | 29.78 | 0.942 | 0.101 | 1M | MVS |
| Point- | 33.31 | 0.978 | 0.049 | 500K | 29.61 | 0.954 | 0.116 | 2M | MVS |
| NeRF | | | | | | | | | |
| Method | 32.07 | 0.971 | 0.038 | 30K | 28.06 | 0.928 | 0.095 | 30K | Random |
| 500 | | | | | | | | | |

Table 2 shows a comparison of image quality metrics (PSNR, SSIM, and LPIPS) on the NeRF Synthetic dataset and Tanks & Temples subset. Higher PSNR and SSIM scores are better, while lower LPIPS scores indicate better perceptual quality. The method 500 outperforms all baselines in terms of perceptual quality, as indicated by LPIPS, while achieving competitive performance in PSNR and SSIM. Additionally, the method 500 achieves these results using significantly fewer points compared to the leading baselines, without relying on specific initialization. These findings highlight the ability of the method 500 to render high perceptual quality images with a compact number of points.

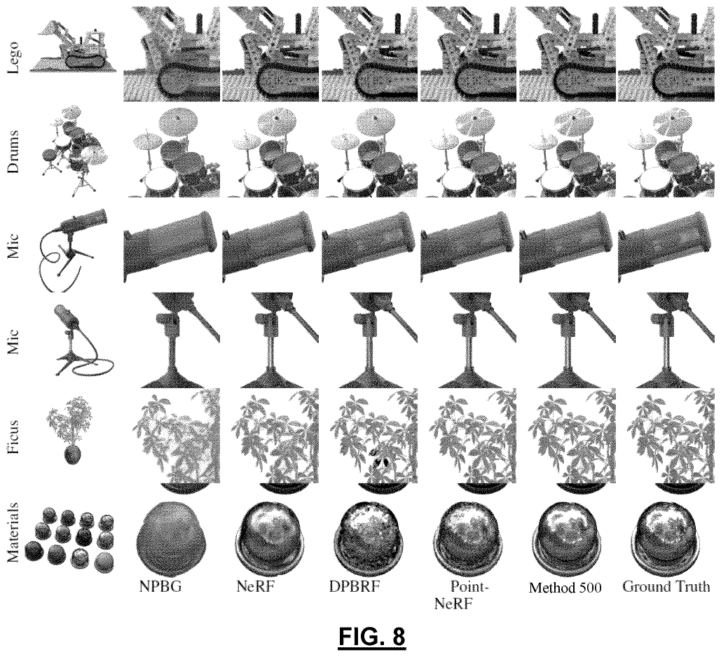

The example experiments also qualitatively compared the method 500 with the baselines on the NeRF Synthetic dataset. As shown in FIG. 8, the method 500 produced images with more details compared to the baselines. Notably, the results exhibit a notable absence of high-frequency noise, unlike the leading baseline, Point-NeRF. This is particularly evident in areas such as the shiny ball in the last row and the microphone stand in the fourth row. These results validate the effectiveness of the method 500 in capturing fine details and generating realistic renderings compared to the baselines.

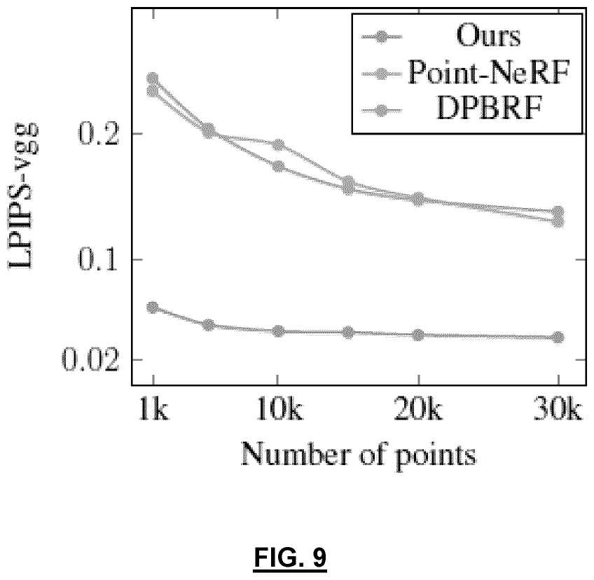

The example experiments also analyzed the impact of number of points on the rendered image quality in the method 500. The evaluation was performed using the LPIPS metric on the testing views for a Lego Scene of the NeRF synthetic dataset. Additionally, the example experiments compared the performance of the method 500 to that of DPBRF and Point-NeRF. As shown in FIG. 9, the method achieves better perceptual image rendering quality by using a higher number of points. Furthermore, the method 500 consistently outperforms the baselines by a significant margin when using the same number of points. It can be further observed that the method 500 exhibits greater robustness in rendering quality as the number of points decreases, in comparison to the baselines. These findings highlight the effectiveness of the method 500 in representing the scene with high rendering quality while using a small number of points.

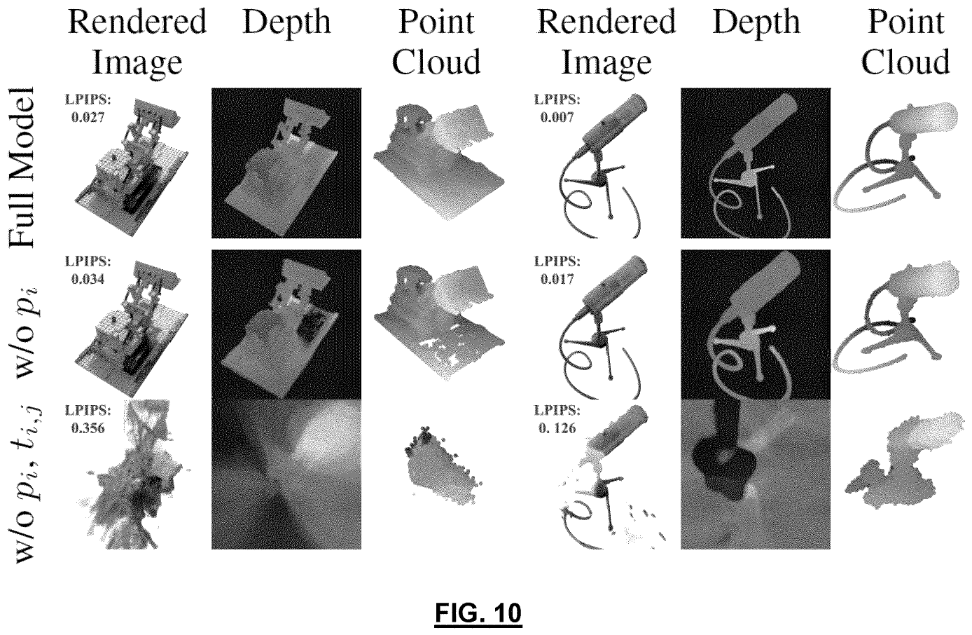

The example experiments also analyzed the ray-dependent point embedding by gradually removing components, including the point position pᵢ and the displacement vector t_{i,j}. It was observed that when the point position p; was removed, the learned point cloud exhibits increased noise, indicating the significance of incorporating this component. Similarly, removing the displacement vector t_{i,j} leads to the model's failure in learning the correct geometry. These findings validate the effectiveness of the point embedding of the method 500 and highlight the effectiveness of both the point position and displacement vector in achieving accurate and high-quality results. This analysis is illustrated in FIG. 10.

Although the invention has been described with reference to certain specific embodiments, various modifications thereof will be apparent to those skilled in the art without departing from the spirit and scope of the invention as outlined in the claims appended hereto.

1. A processor-executed method for accelerated operation of layers used in a machine learning model, the method comprising:
receiving rows or columns of a weight matrix, an input vector, and columns of an identity matrix, where each row or column of the weight matrix is associated with a value vector;
transforming the rows or columns of the weight matrix and the input vector using an embedding function;
performing a search to identify transformed rows or columns of the weight matrix that are to receive high post-activations based on each of the transformed input vector;
determining post-activations using similarity of the rows or columns of the weight matrix that were returned by the search to the associated input vector as measured by a kernel function; and
outputting the post-activations for operation of the machine learning model.

2. The method of claim 1, further comprising determining an output matrix comprising making the output matrix equivalent to the post-activations where the post-activations are value vectors, and otherwise, combining the post-activations with the associated value vectors, and outputting the output matrix for use in the machine learning model.

3. The method of claim 1, wherein transforming the rows or columns of the weight matrix and the input vector using the embedding function comprises embedding the rows or columns of the weight matrix and the input vector into a higher dimensional space.

4. The method of claim 1, wherein the search comprises a k-nearest neighbour search over the transformed rows or columns of the weight matrix given each transformed query to identify transformed rows or columns of the weight matrix that have higher importance to each of the transformed input vector.

5. The method of claim 1, wherein the search comprises one of:
returning all or a subset of points within a particular radius of the query or whose similarities to the query pass a threshold;
determining points that are near or similar to the query;
clustering points that are near or similar to one another and return points in clusters that are near the query;
constructing a graph with points as nodes and connect nearby or similar points with edges and traverse the graph; and
estimating a probability density of points and return points near or similar to the query whose probability densities pass a threshold.

6. The method of claim 1, further comprising receiving a mask matrix, wherein the search uses only rows or columns of the weight matrix that are not masked in the mask matrix.

7. The method of claim 1, wherein determining the post-activations further comprises modifying post-activations to account for the post-activations of the rows or columns of the weight matrix that were not identified by the search.

8. The method of claim 7, wherein the rows or columns of the weight matrix that were not identified in the search are treated as if the kernel function applied to each of those rows or columns of the weight matrix and the query evaluates to a constant.

9. The method of claim 8, wherein a value of the constant is fixed or wherein the value of the constant is determined by sampling a subset of rows or columns of the weight matrix at random, wherein during such determination, the kernel function is evaluated by application to the sampled rows or columns of the weight matrix and the query, and the evaluations are combined for each key by determining an average.

10. The method of claim 1, wherein the layer comprises an attention operation, the post-activations comprise attention weights, and the rows or columns of the weight matrix comprise keys.

11. A system for accelerated attention operations for use in a machine learning model, the system comprising a processing unit and a data storage, the data storage comprising executable instructions that when executed by the processing unit cause to the system to:
receive rows or columns of a weight matrix, an input vector, and columns of an identity matrix, where each row or column of the weight matrix is associated with a value vector;
transform the rows or columns of the weight matrix and the input vector using an embedding function;
perform a search to identify transformed rows or columns of the weight matrix that are to receive high post-activations based on each of the transformed input vector;
determine post-activations using similarity of the rows or columns of the weight matrix that were returned by the search to the associated input vector as measured by a kernel function; and
output the post-activations for operation of the machine learning model.

12. The method of claim 11, the data storage further comprising executable instructions to determine an output matrix comprising making the output matrix equivalent to the post-activations where the post-activations are value vectors, and otherwise, combining the post-activations with the associated value vectors, and to output the output matrix for use in the machine learning model.

13. The system of claim 11, wherein transforming the rows or columns of the weight matrix and the input vector using the embedding function comprises embedding the rows or columns of the weight matrix and the input vector into a higher dimensional space.

14. The system of claim 11, wherein the search comprises a k-nearest neighbour search over the transformed rows or columns of the weight matrix given each transformed query to identify transformed rows or columns of the weight matrix that have higher importance to each of the transformed input vector.

15. The system of claim 11, wherein the search comprises one of:
returning all or a subset of points within a particular radius of the query or whose similarities to the query pass a threshold;
determining points that are near or similar to the query;
clustering points that are near or similar to one another and return points in clusters that are near the query;
constructing a graph with points as nodes and connect nearby or similar points with edges and traverse the graph; and
estimating a probability density of points and return points near or similar to the query whose probability densities pass a threshold.

16. The system of claim 11, wherein determining the post-activations further comprises modifying post-activations to account for the post-activations of the rows or columns of the weight matrix that were not identified by the search.

17. The system of claim 16, wherein the rows or columns of the weight matrix that were not identified in the search are treated as if the kernel function applied to each of those rows or columns of the weight matrix and the query evaluates to a constant.

18. The system of claim 17, wherein a value of the constant is fixed or wherein the value of the constant is determined by sampling a subset of rows or columns of the weight matrix at random, wherein during such determination, the kernel function is evaluated by application to the sampled rows or columns of the weight matrix and the query, and the evaluations are combined for each key by determining an average.

19. The system of claim 11, wherein the layer comprises an attention operation, the post-activations comprise attention weights, and the rows or columns of the weight matrix comprise keys.

20. A processor-executed method for differentiable point rendering using proximity attention to learn a representation of a three-dimensional (3D) scene, the method comprising:
receiving an input matrix derived from a set of images;
initializing points in the 3D scene;
extracting ray-to-point features using the points and the input matrix;
aggregating the ray-to-point features to generate a feature map that represents surface-ray intersections;
generating an image prediction, using a convolutional neural network, and taking the feature map as input; and
outputting the image prediction as the representation of the 3D scene.
